(19) United States
(12) Patent Application Publication
(10) Pub. No.: US 2016/0127863 A1
(43) Pub. Date: May 5, 2016

(54) METHOD FOR PROVIDING LOCATION BASED SERVICE AND ELECTRONIC DEVICE THEREFOR

(71) Applicant: Samsung Electronics Co., Ltd., Gyeonggi-do (KR)

(72) Inventors: Su-Ha YOON, Seoul (KR); Su-Young PARK, Gyeonggi-do (KR); Eui-Chang JUNG, Seoul (KR); Jae-Hun JEONG, Gyeonggi-do (KR)

(73) Assignee: Samsung Electronics Co., Ltd.

(21) Appl. No.: 14/928,658

(22) Filed: Oct. 30, 2015

(30) Foreign Application Priority Data
Oct. 30, 2014 (KR) 10-2014-0149151

(51) Int. Cl. H04W 4/02; G01S 5/02; H04W 8/18; G01S 5/00; H04L 29/08; H04M 3/24

(52) U.S. Cl. CPC H04W 4/02; H04L 67/22; H04M 3/24; H04W 8/183; G01S 5/0027; G01S 5/0236

(57) ABSTRACT

Methods and apparatuses are provided for operating an electronic device. A wireless signal is received. It is determined whether a service corresponding to the wireless signal is activated or deactivated. Content related to the service is output based on whether the service is activated or deactivated.

### PRIORITY

This application claims priority under 35 U.S.C. §119(a) to Korean Application Serial No. 10-2014-0149151, which was filed in the Korean Intellectual Property Office on Oct. 30, 2014, the content of which is incorporated herein by reference.

### BACKGROUND

1. Field of the Invention

The present disclosure generally relates to an electronic device, and more particularly, to a method and an electronic device for providing a location based service.

2. Description of the Related Art

With the development of information communication technologies and semiconductor technologies, various electronic devices have developed into multimedia devices that provide various multimedia services. For example, the electronic device provides multimedia services such as, for example, a messenger service, a broadcasting service, a wireless Internet service, a camera service, and a music playing service.

The electronic device may receive various service related content according to a location of the electronic device while using a wireless communication. For example, the electronic device may receive service related content provided by a store or a company through an electronic device installed in an adjacent store or building.

However, the electronic device may receive the service related content regardless of a capability or a state of a user. That is, the electronic device may indiscriminately receive the service related content without consideration of the capability (e.g., a used language, a disability or ability, an age, and the like) of the user or the state (e.g., driving, in a meeting, watching a movie, on the phone, sleeping, and the like) of the user.

### SUMMARY

The present disclosure has been made to address at least the above problems and/or disadvantages and to provide at least the advantages described below. Accordingly, an aspect of the present disclosure provides a location-based service capable of selectively receiving service related content provided from a service provider, in consideration of a capability of a user or a state of the user.

According to an aspect of the present disclosure, an electronic device is provided that includes a communication interface and an output device. The electronic device also includes a processor configured to receive a wireless signal through the communication interface, determine whether a service corresponding to the wireless signal is activated or deactivated, and output content related to the service through the output device based on whether the service is activated or deactivated.

According to an aspect of the present disclosure, a method is provided for operating an electronic device. A wireless signal is received. It is determined whether a service corresponding to the wireless signal is activated or deactivated. Content related to the service is output based on whether the service is activated or deactivated.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a diagram illustrating a network environment including an electronic device, according to an embodiment of the present disclosure;

FIG. 2 is a block diagram illustrating an electronic device, according to an embodiment of the present disclosure;

FIG. 3 is a block diagram illustrating a program module, according to an embodiment of the present disclosure;

FIG. 4 illustrates a frequency band and a channel configuration for providing a location based service, according to an embodiment of the present disclosure;

FIG. 5 is a diagram illustrating a configuration of an advertising packet, according to an embodiment of the present disclosure;

FIG. 6 is a diagram illustrating a network environment of a gimbal service, which is a location based service method, according to an embodiment of the present disclosure;

FIG. 7 is a diagram illustrating a 3GPP network environment, which is a location based service method, according to an embodiment of the present disclosure;

FIG. 8 is a diagram illustrating a procedure of issuing a ProSe application code through a network by a User Equipment (UE), according to an embodiment of the present disclosure;

FIG. 9 is a diagram illustrating a procedure in which a UE requests a discovery filter to a network and receives from the discovery filter from the network, in order to monitor a ProSe application code, according to an embodiment of the present disclosure;

FIG. 10 is a diagram illustrating a procedure for identifying a ProSe application identifier when the ProSe application identifier is not stored in a UE, according to an embodiment of the present disclosure;

FIG. 11 illustrates a configuration of a venue info field in IEEE 802.11u, according to an embodiment of the present disclosure;

FIG. 12 is a diagram illustrating a network environment of a Mobility Services Advertising Protocol (MSAP), which is a location based service method, according to an embodiment of the present disclosure;

FIGS. 13 to 17 are diagrams illustrating a list configuration of a service displayed through a service management program, according to an embodiment of the present disclosure;

FIG. 18 is a diagram illustrating a procedure for exchanging service related information between a service management program server and a service server, according to an embodiment of the present disclosure;

FIG. 19 is a diagram illustrating a procedure for exchanging service related information between a UE and a service management program server, according to an embodiment of the present disclosure;

FIG. 20 is a diagram illustrating a procedure for sharing a service between a first UE and a second UE, according to an embodiment of the present disclosure;

FIG. 21 is a flowchart illustrating a procedure for an operation method of a UE when a service related signal is received, according to an embodiment of the present disclosure;

FIG. 22 is a diagram illustrating a network environment of a Proximity Service (ProSe), according to an embodiment of the present disclosure;

FIG. 23 is a diagram illustrating a procedure for transmitting service identifier information to a ProSe function from a service server through a service management program server, according to an embodiment of the present disclosure;

FIG. 24 is a diagram illustrating a procedure for receiving a service identifier from a service management program server in a UE, according to an embodiment of the present disclosure;

FIG. 25 and FIG. 26 are diagrams illustrating a procedure for transmitting a discovery request from a UE to a ProSe function, according to an embodiment of the present disclosure;

FIG. 27 is a diagram illustrating a configuration of a UE, according to an embodiment of the present disclosure;

FIG. 28 is a diagram illustrating a list configuration of a service displayed through a service management program in a UE, according to an embodiment of the present disclosure;

FIG. 29 and FIG. 30 are diagrams illustrating a procedure for transferring an announcement to a user, according to an embodiment of the present disclosure;

FIG. 31 is a diagram illustrating a block configuration of a UE, according to an embodiment of the present disclosure;

FIG. 32 is a diagram illustrating a configuration of an advertising packet, according to an embodiment of the present disclosure;

FIG. 33 and FIG. 34 are diagrams illustrating a procedure for transmitting a discovery request from a UE to a ProSe function, according to an embodiment of the present disclosure;

FIG. 35 is a flowchart illustrating a procedure for determining whether a UE transfers a notification based on whether a UE is moved, according to an embodiment of the present disclosure;

FIG. 36 is a flowchart illustrating a procedure for determining whether a UE transfers a notification based on attributes of an application or whether the UE moves, according to an embodiment of the present disclosure;

FIGS. 37 to 40 are diagrams illustrating a coupon list configuration, according to an embodiment of the present disclosure;

FIG. 41 and FIG. 42 are diagrams illustrating a configuration of an application (i.e., service), according to an embodiment of the present disclosure;

FIG. 43 is a diagram illustrating a configuration of an application having a plurality of contents included in a UE, according to an embodiment of the present disclosure;

FIG. 44 is a flowchart illustrating a procedure for providing contents based on a capability of a user and a UE state, according to an embodiment of the present disclosure;

FIG. 45 is a diagram illustrating a configuration of an application having a plurality of contents included in a server, according to an embodiment of the present disclosure;

FIG. 46 is a flowchart illustrating a procedure for providing contents based on a capability of a user and a UE state, according to an embodiment of the present disclosure;

FIG. 47 is a diagram illustrating a procedure for transmitting a discovery request from a UE to a ProSe function, according to an embodiment of the present disclosure;

FIG. 48 is a flowchart illustrating a procedure for executing contents by receiving a ProSe application code by a UE, according to embodiments of the present disclosure;

FIG. 49 is a flowchart illustrating a procedure for transmitting a content identifier and a content type from a UE to an application server by receiving a ProSe application code, according to an embodiment of the present disclosure;

FIG. 50 is a flowchart illustrating a procedure for transmitting a discovery filter as a discovery response from a ProSe function to a monitor UE because the ProSe function receives a discovery request, according to an embodiment of the present disclosure;

FIG. 51 is a diagram illustrating a configuration of a content identifier and a content type list, according to an embodiment of the present disclosure;

FIG. 52 is a diagram illustrating a network environment among a headquarters server, a branch server, and an announcer, according to an embodiment of the present disclosure;

FIG. 53 is a diagram illustrating a configuration of an announcement, according to an embodiment of the present disclosure;

FIG. 54 is a diagram illustrating a configuration of a database included in a headquarters server, according to an embodiment of the present disclosure;

FIG. 55 is a diagram illustrating a configuration of a database included in a branch server, according to an embodiment of the present disclosure;

FIG. 56 is a flowchart illustrating a procedure for performing communication between a UE and a branch server, according to an embodiment of the present disclosure; and

FIG. 57 is a diagram illustrating a network environment among a headquarters server, a branch server, a UE, and an announcer, according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions or constructions or processes known in the art may be omitted to avoid obscuring the subject matter of the present disclosure.

The terms “have,” “may have,” “include,” and “may include”, as used herein, indicate the presence of corresponding features (for example, elements such as numerical values, functions, operations, or parts), and do not preclude the presence of additional features.

The terms “A or B,” “at least one of A and B,” or “one or more of A and B”, as used herein, include all possible combinations of items enumerated with them. For example, “A or B,” “at least one of A and B,” or “one or more of A and B” means (1) including at least one A, (2) including at least one B, or (3) including both at least one A and at least one B.

The terms such as “first” and “second”, as used herein, may modify various elements regardless of an order and/or importance of the corresponding elements, and does not limit the corresponding elements. These terms may be used for the purpose of distinguishing one element from another element. For example, a first user device and a second user device may indicate different user devices regardless of their order or importance. For example, a first element may be referred to as a second element without departing from the scope of embodiments of the present invention, and similarly, a second element may be referred to as a first element.

It will be understood that, when an element (for example, a first element) is “(operatively or communicatively) coupled with/to” or “connected to” another element (for example, a second element), the first element may be directly coupled with/to the second element, or there may be an intervening element (for example, a third element) between the first element and the second element. To the contrary, it will be understood that, when an element (for example, the first element) is “directly coupled with/to” or “directly connected to” another element (for example, the second element), there is no intervening element (for example, the third element) between the first element and the second element.

The expression “configured to (or set to)”, as used herein, may be replaced with “suitable for,” “having the capacity to,” “designed to,” “adapted to,” “made to,” or “capable of”, according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The terms used in the various embodiments of the present disclosure are just for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined in the various embodiments. According to circumstances, even terms defined in the embodiments should not be interpreted as excluding other embodiments of the present disclosure.

An electronic device, according to various embodiments of the present disclosure, may include at least one of a smartphone, a tablet Personal Computer (PC), a mobile phone, a video phone, an electronic book reader, a desktop PC, a laptop PC, a netbook computer, a workstation, a server, a Personal Digital Assistant (PDA), a Portable Multimedia Player (PMP), an MP3 player, a mobile medical machine, a camera, or a wearable device (for example, smart glasses, a Head Mounted Device (HMD), electronic clothing, an electronic bracelet, an electronic necklace, an electronic appcessory, electronic tattoos, a smart mirror, or a smart watch).

According to embodiments of the present disclosure, the electronic device may be a smart home appliance. For example, the smart home appliance may include at least one of a television, a Digital Versatile Disc (DVD) player, a stereo, a refrigerator, an air conditioner, a cleaner, an oven, a microwave oven, a washing machine, an air cleaner, a set-top box, a home automation control panel, a security control panel, a TV box, a game console, an electronic dictionary, an electronic key, a camcorder, or an electronic album.

According to another embodiment, the electronic device may include at least one of various medical machines (for example, various portable medical measurement devices (a glucose monitor, a heart rate monitor, a blood pressure measuring device, or a thermometer), Magnetic Resonance Angiography (MRA), Magnetic Resonance Imaging (MRI), Computerized Tomography (CT), a tomograph, an ultrasound machine, and the like), a navigation device, a Global Positioning System (GPS) receiver, an Event Data Recorder (EDR), a Flight Data Recorder (FDR), an automotive infotainment device, electronic equipment for ship (for example, a navigation equipment for ship, a gyro compass, and the like), avionics, a security device, a head unit for vehicles, an industrial or home robot, an Automated Teller Machine (ATM) of a financial institution, Point of Sales (POS) device of a store, or Internet of Things (IoT) (for example, a lamp, various sensors, an electric or gas meter, a sprinkler, a fire alarm, a thermostat, a streetlamp, a toaster, an exercising machine, a hot water tank, a heater, a boiler, etc.).

According to an embodiment, the electronic device may include at least one of a part of furniture or a building/a structure, an electronic board, an electronic signature-receiving device, a projector, and various measurement devices (for example, devices for measuring water, power, gas, radio waves, and the like). The electronic device, according to various embodiments, may be one or a combination of one or more of the above-described devices. In addition, the electronic device, according to various embodiments, may be a flexible electronic device. In addition, the electronic device, according to various embodiments, is not limited to the above-described devices, and may include a new electronic device accompanied by technology development.

The term “user”, as used herein, may refer to a person who uses the electronic device or a device that uses the electronic device (for example, an artificial intelligence electronic device).

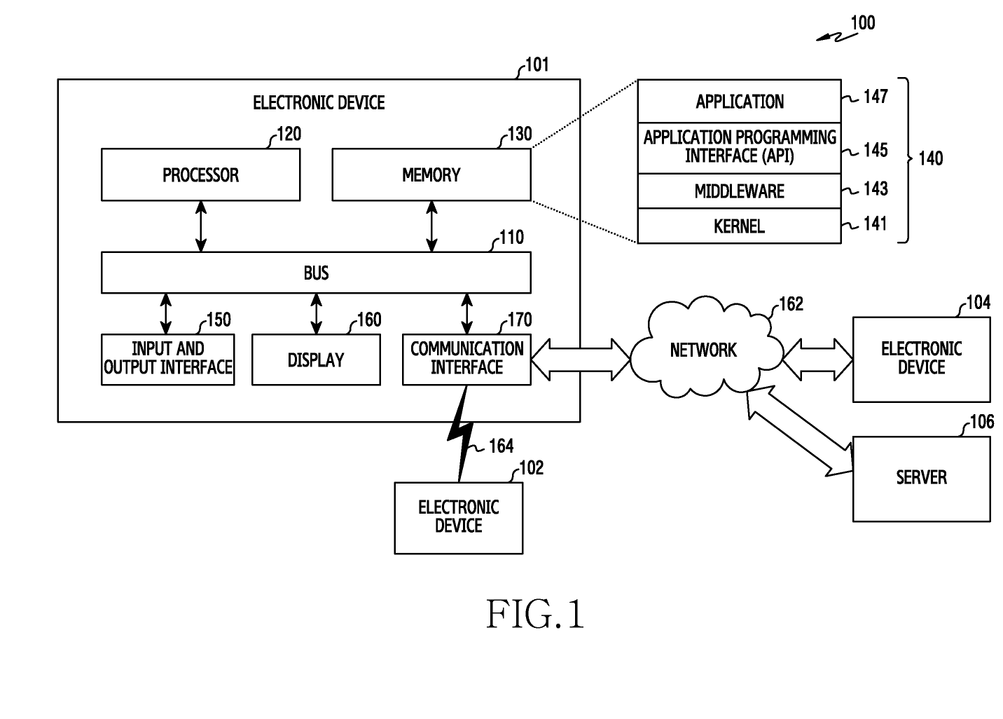

FIG. 1 is a diagram illustrating a network environment including an electronic device, according to an embodiment of the present disclosure.

Referring to FIG. 1, an electronic device 101 in a network environment 100 is described. The electronic device 101 includes a bus 110, a processor 120, a memory 130, an input and output interface 150, a display 160, and a communication interface 170. According to an embodiment, the electronic device 101 may omit at least one of the elements or may include additional elements.

The bus 110 may include a circuit that connects the elements 110-170 with one another and transmits communication (for example, a control message and/or data) between the elements.

The processor 120 may include one or more of a Central Processing Unit (CPU), an Application Processor (AP), or a Communication Processor (CP). The processor 120 may execute calculation or data processing related to control and/or communication of at least one other element of the electronic device 101.

According to an embodiment, the processor 120 may selectively output contents related to a service through an output device (e.g., the display 160 and the like) based on an activation or deactivation of the service corresponding to a wireless signal received through the communication interface 170. For example, the processor 120 may identify the activation or deactivation of the service based on at least one of an identifier, a search filter, a server address of a service included in the received wireless signal or corresponding to the received wireless signal through the communication interface 170. For example, the processor 120 may output the contents related to the service based on at least one of a capability of a user of the electronic device 101, information on whether the electronic device is moved or fixed or a mobility of the electronic device, and an operation mode of the electronic device 101. The capability of the user of the electronic device 101 may include at least one of a language configured in the electronic device 101, a disability or ability of the user, and an age of the user. In addition, the operation mode of the electronic device 101 may include at least one of a driving mode, a meeting mode, a movie watching mode, a call mode, and a sleep mode configured in the electronic device 101.

According to an embodiment, when a corresponding service is activated, the processor 120 may receive content (e.g., music content, image content, a coupon, and the like) related to the corresponding service. For example, when the service is activated, the processor 120 may extract the content related to the service in the wireless signal received through the communication interface 170. In addition, when the service is activated, the processor 120 may obtain the content related to the corresponding service from a server 106. For example, the processor 120 may transmit a transmission request signal of the content related to the service to the server 106 through the communication interface 170.

According to an embodiment, when the service is activated, the processor 120 may control the output device (e.g., the display 160 and the like), such that the output device generates at least one of a vibration, a sound, and a screen turning on, corresponding to the activation of the service.

According to an embodiment, when the service is not activated, the processor 120 may control the output device, such that the output device outputs information for determining whether the service is activated. The information for determining whether the service is activated may include at least one of a menu, an icon, and a pop-up.

According to an embodiment, when a sharing event for the contents related to the service output through the output device is generated, the processor 120 may control the communication interface 170, such that the communication interface 170 transmits the contents to at least one external electronic device (e.g., the first external electronic device 102 or the second external electronic device 104).

The memory 130 may include a volatile and/or non-volatile memory. For example, the memory 130 may store instructions or data, which is related to at least one other element of the electronic device 101. According to an embodiment, the memory 130 may store software and/or a program 140. For example, the program 140 includes at least one of a kernel 141, middleware 143, an Application Programming Interface (API) 145, and an application program (or an application) 147. At least some of the kernel 141, the middleware 143, or the API 145 may be referred to as an Operating System (OS).

For example, the kernel 141 may control or manage system resources (for example, the bus 110, the processor 120, the memory 130, and the like), which are used for performing operations or functions implemented in the other programs (for example, the middleware 143, the API 145, or the application 147). In addition, the kernel 141 may provide an interface for allowing the middleware 143, the API 145, or the application program 147 to access an individual element of the electronic device 101 and control or manage the system resources.

For example, the middleware 143 may serve as an intermediary to allow the API 145 or the application program 147 to communicate with the kernel 141 and exchange data with the kernel 141.

In addition, the middleware 143 may process one or more operation requests received from the application program 147 according to priority. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

For example, the API 145 may be an interface for allowing the application 147 to control a function provided by the kernel 141 or the middleware 143, and, for example, may include at least one interface or function (for example, instructions) for controlling a file, controlling a window, processing an image, or controlling a text.

For example, the input and output interface 150 may serve as an interface for transmitting instructions or data inputted from a user or another external device to other element(s) of the electronic device 101. In addition, the input and output interface 150 may output instructions or data received from other element(s) of the electronic device 101 to the user or the other external device.

For example, the display 160 may include a Liquid Crystal Display (LCD), a Light Emitting Diode (LED) display, an Organic LED (OLED) display, or a MicroElectroMechanical System (MEMS) display, or an electronic paper display. The display 160 may display various pieces of content (for example, text, an image, a video, an icon, a symbol, etc.) for the user. The display 160 may include a touch screen, and for example, may receive input of a touch using an electronic pen or a part of a user's body, a gesture, approach, or hovering.

According to an embodiment, the display 160 may output the contents related to the corresponding service based on the activation or deactivation of the service corresponding to the received wireless signal. According to an embodiment, when the service is activated, the display 160 may generate at least one of a vibration, a sound and a screen turning on corresponding to the content related to the service. According to an embodiment, when the service is not activated, the display 160 may output the information (e.g., the menu, the icon, the pop-up and the like) for determining whether the service is activated.

For example, the communication interface 170 may establish communication between the electronic device 101 and a first external electronic device 102, a second external electronic device 104, or the server 106. For example, the communication interface 170 may be connected to a network 162 via wireless communication or wire communication to communicate with the second external electronic device 104, or the server 106.

The wireless communication may use, as a cellular communication protocol, at least one of Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), or Global System for Mobile Communications (GSM), etc. In addition, for example, the wireless communication may include short-distance communication 164. For example, the short-distance communication 164 may include at least one of Wireless Fidelity (WiFi), Bluetooth, Near Field Communication (NFC), GPS, etc. The wire communication may include at least one of a Universal Serial Bus (USB), a High Definition Multimedia Interface (HDMI), a Recommended Standard 232 (RS-232), or Plain Old Telephone Service (POTS). The network 162 may include a telecommunications network, for example, at least one of a computer network (for example, a LAN or WAN), Internet, or a telephone network.

Each of the first external electronic device 102 and the second external electronic device 104 may be the same type of electronic device as the electronic device 101 or a different kind of device. According to an embodiment, the server 106 may include a group of one or more servers. According to various embodiments, all or a part of the operations executed in the electronic device 101 may be executed in another electronic device or a plurality of other electronic devices (for example, the first or second external electronic devices 102, 104 or the server 106). According to an embodiment, when the electronic device 101 should perform a certain function or service automatically or in response to a request, the electronic device 101 may request another external electronic device 102, 104 or the server 106 to perform at least some function related to the certain function or service additionally or instead of executing the function or service by itself. Another external electronic device 102, 104 or the server 106 may execute the requested function or additional function, and transmit the result to the electronic device 101. The electronic device 101 may process the received result as it is or additionally, and provide the requested function or service. To achieve this, cloud computing, distributed computing, or client-server computing technology may be used, for example.

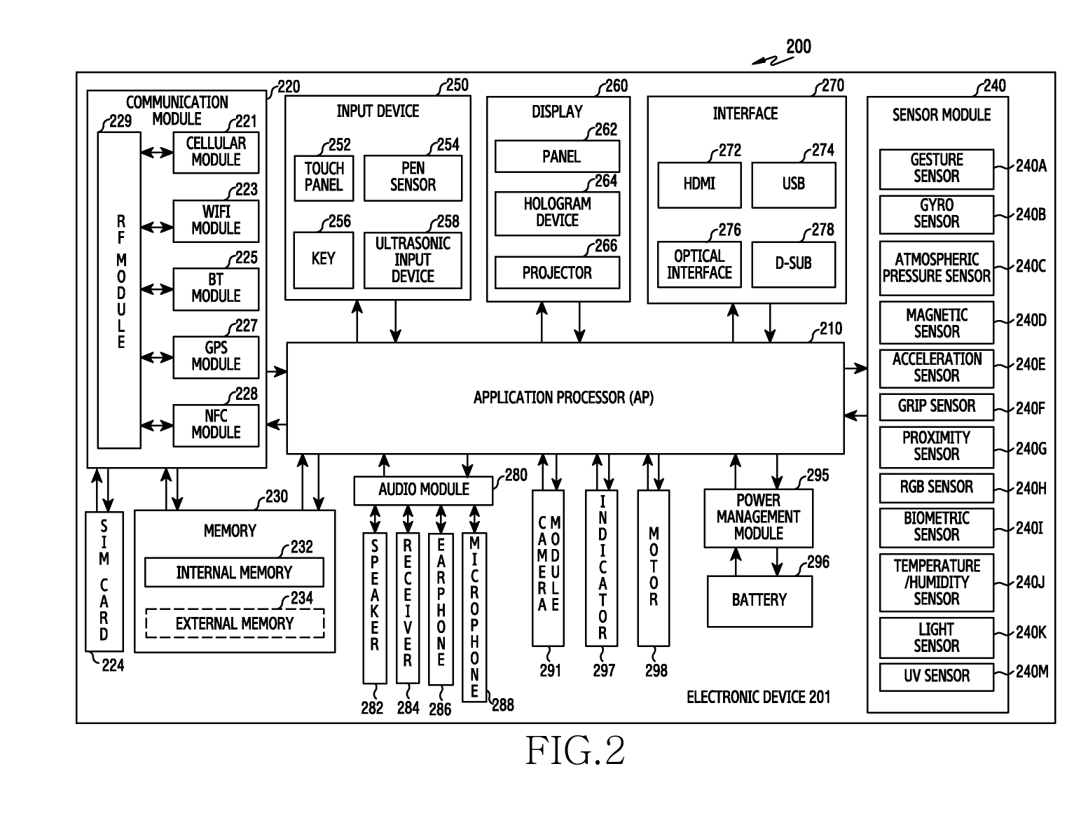

FIG. 2 is a diagram illustrating a block diagram of an electronic device, according to an embodiment of the present disclosure. For example, an electronic device 201 may include an entirety or a part of the electronic device 101 shown in FIG. 1.

Referring to FIG. 2, the electronic device 201 includes one or more processors 210 (for example, an AP), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software elements connected to the processor 210 by driving an operating system or an application program, and may process and calculate various data. For example, the processor 210 may be implemented by using a System on Chip (SoC). According to an embodiment, the processor 210 may further include a Graphic Processing Unit (GPU) and/or an image signal processor. The processor 210 may include at least part of the elements shown in FIG. 2 (for example, a cellular module 221). The processor 210 may load instructions or data received from at least one of the other elements (for example, a non-volatile memory) into a volatile memory and process the instructions or data, and may store various data in the non-volatile memory.

The communication module 220 may have a same or similar configuration as that of the communication interface 170 of FIG. 1. For example, the communication module 220 includes at least one of the cellular module 221, a WiFi module 223, a BT module 225, a GPS module 227, an NFC module 228, and a Radio Frequency (RF) module 229.

The cellular module 221 may provide a voice call, a video call, a text service, or an internet service through a telecommunications network. According to an embodiment, the cellular module 221 may identify and authenticate the electronic device 201 in the telecommunications network by using the subscriber identification module 224. According to an embodiment, the cellular module 221 may perform at least some of the functions provided by the processor 210. According to an embodiment, the cellular module 221 may include a communication processor (CP).

The WiFi module 223, the BT module 225, the GPS module 227, or the NFC module 228 each may include a processor for processing data received and transmitted through a corresponding module. According to an embodiment, at least some (for example, two or more) of the cellular module 221, the WiFi module 223, the BT module 225, the GPS module 227, or the NFC module 228 may be included in a single Integrated Chip (IC) or a single IC package.

The RF module 229 may transmit and receive communication signals (for example, an RF signal). For example, the RF module 229 may include a transceiver, a Power Amp Module (PAM), a frequency filter, a Low Noise Amplifier (LNA), an antenna, etc. According to another embodiment, at least one of the cellular module 221, the WiFi module 223, the BT module 225, the GPS module 227, or the NFC module 228 may transmit and receive an RF signal through a separate RF module.

The subscriber identification module 224 may include a card and/or an embedded SIM, and may include its unique identification information (for example, an Integrated Circuit Card Identifier (ICCID)) or subscriber information (for example, International Mobile Subscriber Identity (IMSI)).

The memory 230 (for example, the memory 130) includes at least one of an internal memory 232 or an external memory 234. For example, the internal memory 232 may include at least one of a volatile memory (for example, a Dynamic Random Access Memory (DRAM), a Static Random Access Memory (SRAM), a Synchronous DRAM (SDRAM), and the like) and a non-volatile memory (for example, an One-Time Programmable Read Only Memory (OTPROM), a Programmable Read Only Memory (PROM), an Erasable Programmable Read Only Memory (EPROM), an Electrically Erasable Programmable Read Only Memory (EEPROM), a mask ROM, a flash ROM, a flash memory (for example, a NAND flash memory, a NOR flash memory, and the like), a hard drive, a solid state drive (SSD).

The external memory 234 may further include a flash drive, for example, Compact Flash (CF), Secure Digital (SD), Micro-SD, Mini-SD, extreme-Digital (xD), a Multi Media Card (MMC), memory stick, and the like. The external memory 234 may be functionally and/or physically connected with the electronic device 201 through various interfaces.

The sensor module 240 may measure a physical quantity or detect an operation state of the electronic device 201, and may convert measured or detected information into electric signals. The sensor module 240 includes at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., Red, Green, Blue (RGB) sensor), a biosensor 240I, a temperature/humidity sensor 240J, an illumination sensor 240K, and a Ultraviolet (UV) sensor 240M. Additionally or alternatively, the sensor module 240 may include an E-nose sensor, an ElectroMyoGraphy (EMG) sensor, an ElectroEncephaloGram (EEG) sensor, an ElectroCardioGram (ECG) sensor, an InfraRed ray (IR) sensor, an iris sensor, and/or a fingerprint sensor, and the like. The sensor module 240 may further include a control circuit to control at least one sensor included therein. According to an embodiment, the electronic device 201 may further include a processor configured to control the sensor module 240 as a part of the processor 210 or a separate part, and may control the sensor module 240 while the processor 210 is in a sleep state.

The input device 250 includes at least one of a touch panel 252, a (digital) pen sensor 254, a key 256, and an ultrasonic input device 258. The touch panel 252 may use at least one method of capacitive, resistive, infrared, and ultrasonic methods. In addition, the touch panel 252 may further include a control circuit. The touch panel 252 may further include a tactile layer to provide a tactile response to the user.

The (digital) pen sensor 254 may be a part of the touch panel or may include a separate detection sheet. The key 256 may include a physical button, an optical key, or a keypad. The ultrasonic input device 258 may detect ultrasonic waves generated in an input tool through a microphone 288, and identify data corresponding to the detected ultrasonic waves.

The display 260 (e.g., the display 160) includes at least one of a panel 262, a hologram device 264, or a projector 266. The panel 262 may have a same or similar configuration as or to that of the display 160 of FIG. 1. For example, the panel 262 may be implemented to be flexible, transparent, or wearable. The panel 262 may be configured as a single module along with the touch panel 252. The hologram device 264 may show a stereoscopic image in the air using interference of light. The projector 266 may display an image by projecting light onto a screen. The screen may be located inside or outside the electronic device 201. According to an embodiment, the display 260 may further include a control circuit to control the panel 262, the hologram device 264, or the projector 266.

The interface 270 includes at least one of an HDMI 272, a USB 274, an optical interface 276, or D-subminiature (sub) 278. The interface 270 may be included in the communication interface 170 shown in FIG. 1. Additionally or alternatively, the interface 270 may include an MHL interface, an SD card/Multimedia Card (MMC) interface or Infrared Data Association (IrDA) standard interface.

The audio module 280 may convert a sound and an electric signal bidirectionally. For example, at least some elements of the audio module 280 may be included in the input and output interface 150 shown in FIG. 1. The audio module 280 may process sound information that is input or output through a speaker 282, a receiver 284, an earphone 286, or a microphone 288.

The camera module 291 is a device for photographing a still image and a moving image, and, according to an exemplary embodiment, the camera module 291 may include one or more image sensors (for example, a front surface sensor or a rear surface sensor), a lens, an Image Signal Processor (ISP), or a flash (for example, a Light Emitting Diode (LED) or a xenon lamp).

The power management module 295 may manage power of the electronic device 201. According to an embodiment, the power management module 295 may include a Power Management IC (PMIC), a charger IC, or a battery gauge. For example, the PMIC may have a wire charging method and/or a wireless charging method. The wireless charging method may include a magnetic resonance method, a magnetic induction method, or an electromagnetic wave method, and an additional circuit for charging wirelessly, for example, a coil loop, a resonant circuit, a rectifier, and the like may be added. For example, the battery gage may measure a remaining battery life of the battery 296, a voltage, a current, or temperature during charging. The battery 296 may include a rechargeable battery and/or a solar battery.

The indicator 297 may display a specific state of the electronic device 201 or a part of it (for example, the processor 210), for example, a booting state, a message state, or a charging state. The motor 298 may convert an electric signal into a mechanical vibration, and cause a vibration or haptic effect. The electronic device 201 may include a processing device (for example, a GPU) for supporting a mobile TV. The processing device for supporting the mobile TV may process media data according to standards such as Digital Multimedia Broadcasting (DMB), Digital Video Broadcasting (DVB), or media flow.

Each of the above-described elements of the electronic device, according to various embodiments of the present disclosure, may include one or more components, and the names of the elements may vary according to the kind of the electronic device. The electronic device, according to various embodiments, may include at least one of the above-described elements, and some of the elements may be omitted or an additional element may be further included. In addition, some of the elements of the electronic device, according to various embodiments, may be combined into a single entity, and may perform the same functions as those of the elements before being combined.

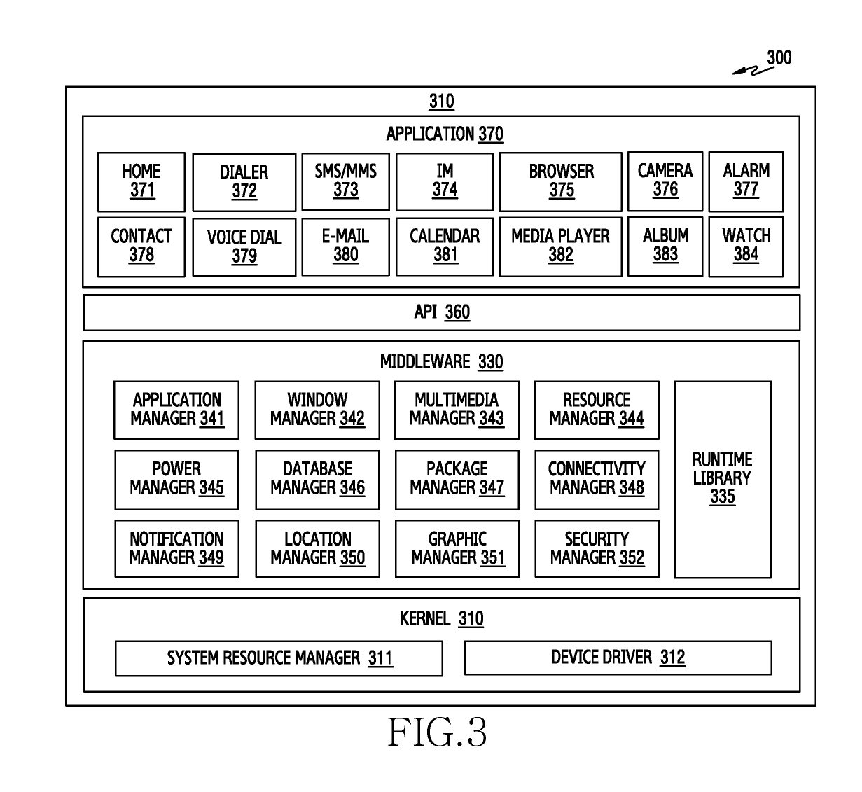

FIG. 3 is a block diagram illustrating a program module, according to an embodiment of the present disclosure. According to an embodiment, a program module 310 (for example, the program 140) may include an Operating System (OS) for controlling resources related to an electronic device 101 and/or various applications 147 driven on the OS.

Referring to FIG. 3, the program module 310 includes a kernel 320, middleware 330, an Application Programming Interface (API) 360, and/or an application 370. At least part of the program module 310 may be preloaded on the electronic device or downloaded from an external device 102, 104, the server 106, or the like.

The kernel 320 (for example, the kernel 141) includes a system resource manager 321 and/or a device driver 323. The system resource manager 321 may control, allocate or collect the system resources. According to an embodiment, the system resource manager 321 may include a process manager, a memory manager, a file system manager, and the like. The device driver 323 may include a display driver, a camera driver, a Bluetooth driver, a shared memory drive; a Universal Serial Bus (USB) driver, a keypad driver, a WiFi driver, an audio driver, or an Inter-Process Communication (IPC) driver, for example.

The middleware 330 may provide functions that are commonly required by the application 370 or may provide various functions to the application 370 through the API 360 such that the application 370 can effectively use limited system resources in the electronic device. According to an embodiment, the middleware 330 (for example, the middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

For example, the runtime library 335 may include a library module that is used by a compiler to add a new function through a programming language while the application 370 is executed. The runtime library 335 may perform functions on input/output management, memory management, an arithmetic function, and the like.

The application manager 341 may manage a life cycle of at least one of the applications 370, for example. The window manager 342 may manage GUI resources used in a screen. The multimedia manager 343 grasps a format necessary for reproducing various media files and encodes or decodes the media files by using a Codec suited to the corresponding format. The resource manager 344 may manage resources such as a source code, a memory, or a storage space of at least one of the applications 370.

The power manager 345 operates along with a Basic Input/Output System (BIOS) to manage a battery or power and provide power information necessary for operations of the electronic device. The database manager 346 may generate, search, or change a database, which is used in at least one of the applications 370. The package manager 347 may manage installing or updating an application that is distributed in the form of a package file.

The connectivity manager 348 may manage wireless connection of WiFi, Bluetooth, and the like. The notification manager 349 may display or notify an event, such as a message arrived, an appointment, a notification of proximity, in such a manner that the event does not hinder the user. The location manager 350 may manage location information of the electronic device. The graphic manager 350 may manage a graphic effect to be provided to the user or a relevant user interface. Herein, the graphic manager 351 may include a dali graphic engine. The security manager 352 may provide an overall security function necessary for system security or user authentication. According to an embodiment, when the electronic device 101 is equipped with a telephony function, the middleware 330 may further include a telephony manager to manage a speech or video telephony function of the electronic device.

The middleware 330 may include a middleware module to form a combination of the various functions of the above-described elements. The middleware 330 may provide a module that is customized according to a kind of OS to provide a distinct function. In addition, the middleware 330 may dynamically delete some of the existing elements or may add new elements.

The API 360 (for example, the API 145) is a set of API programming functions and may be provided as a different configuration according to an OS. For example, a single API set may be provided for each platform, or two or more API sets may be provided for each platform.

The application 370 includes one or more applications for providing functions, such as, for example, a home 371, a dialer 372, a Short Message Service (SMS)/Multimedia Messaging Service (MMS) 373, an Instant Message (IM) 374, a browser 375, a camera 376, an alarm 377, contacts 378, a voice dial 379, an email 380, a calendar 381, a media player 382, an album 383, or a clock 384, or health care (for example, measuring exercise or a blood sugar level), or providing environment information (for example, information on atmospheric pressure, humidity, or temperature).

According to an embodiment of the present disclosure, the applications 370 may include an application (hereinafter, an “information exchange application”) supporting information exchange between the electronic device 101 and an external electronic device 102 or 104. The information exchanged application may include, for example, a notification relay application for transferring specific information to the external electronic device or a device management application for managing the external electronic device.

For example, the notification relay application may include a function of transferring, to the external electronic device 102 or 104, notification information generated from other applications (for example, an SMS/MMS application, an e-mail application, a health management application, or an environmental information application) of the electronic device. Further, the notification relay application may receive notification information from, for example, the external electronic device and provide the received notification information to a user. For example, the device management application may manage (for example, install, delete, or update) at least one function (for example, a function of turning on/off the external electronic device itself (or some components) or a function of adjusting luminance (or a resolution) of the display), applications operating in the external electronic device, or services provided by the external electronic device (for example, a call service and a message service) of the external electronic device 104 communicating with the electronic device.

According to an embodiment, the applications 370 may include an application (for example, health management application) designated according to attributes (for example, attributes of the electronic device such as the type of electronic device which corresponds to a mobile medical device) of the external electronic device 102 or 104. According to an embodiment, the application 370 may include an application received from the external electronic device (e.g., the server 106, or the first or second external electronic device 102 or 104). According to an embodiment, the application 370 may include a preloaded application or a third party application, which can be downloaded from the server. Names of the elements of the program module 310, according to the above-described embodiment, may change depending on the type of OS.

According to various embodiments, at least some of the program module 310 may be implemented in software, firmware, hardware, or a combination of two or more thereof. At least some of the program module 310 may be implemented (e.g., executed) by, for example, the processor (e.g., the AP 210). At least some of the program module 310 may include, for example, a module, a program, a routine, a set of instructions, or a process for performing one or more functions.

An electronic device according to various embodiments of the present disclosure may include a communication interface, an output device, and a processor configured to receive a wireless signal through the communication interface, determine whether a service corresponding to the wireless signal is activated or deactivated, and output content related to the service through the output device based on whether the service is activated or deactivated.

According to various embodiments, the processor may determine whether the service is activated or deactivated based on at least one of an identifier, a search filter, a server address of the service corresponding to the wireless signal.

According to various embodiments, the processor may output the content related to the service based on at least one of a capability of a user of the electronic device, information on whether the electronic device is moved or fixed, information on a mobility of the electronic device, and an operation mode of the electronic device.

According to various embodiments, the capability of the user of the electronic device may include at least one of a language configured in the electronic device, a disability of the user, an ability of the user, and an age of the user.

According to various embodiments, the operation mode of the electronic device may include at least one of a driving mode, a meeting mode, a movie watching mode, a call mode, and a sleep mode configured in the electronic device.

According to various embodiments, when it is determined that the service is activated, the processor is further configured to extract the content related to the service from the wireless signal.

According to various embodiments, when it is determined that the service is activated, the processor is further configured to obtain the content related to the service from a server.

According to various embodiments, when it is determined that the service is activated, the processor may control the output device such that the output device generates at least one of a vibration, a sound and a screen turning on corresponding to the activation of the service.

According to various embodiments, when the service it is determined that the service is deactivated, the processor is further configured to control the output device such that the output device outputs information for determining whether the service is activated.

According to various embodiments, when a sharing event for the content related to the service output through the output device is generated, the processor is further configured to control the communication interface such that the communication interface transmits the content to at least one external electronic device.

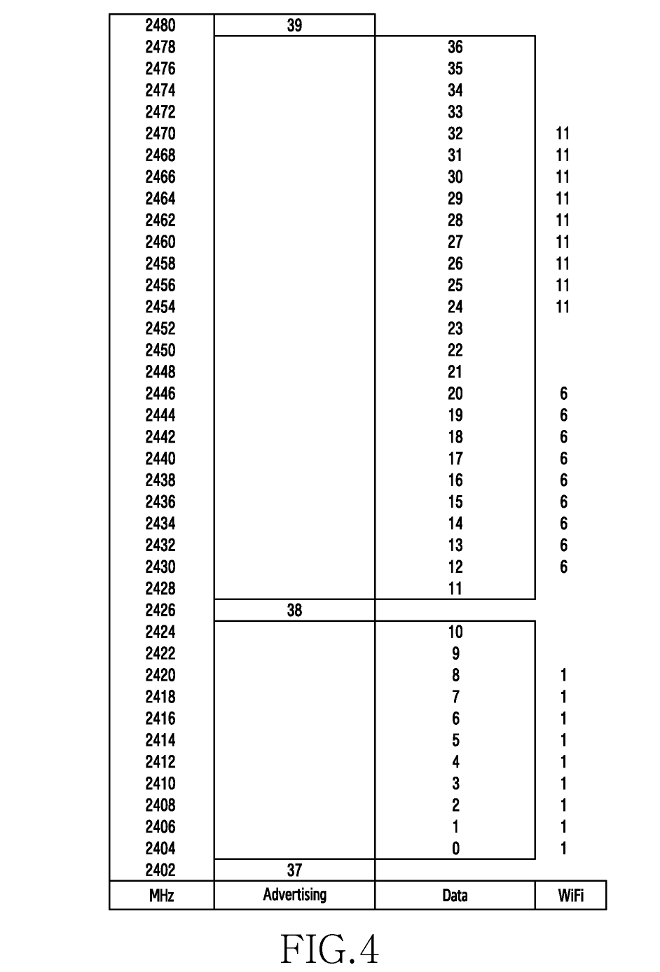

FIG. 4 illustrates a frequency band and a channel configuration for providing a location-based service, according to an embodiment of the present disclosure.

According to an embodiment, the frequency band and the channel configuration for providing the location-based service may be determined as shown in FIG. 4. According to an embodiment, the location-based service may provide a service based on a Bluetooth Low Energy (BLE) method. For example, the location-based service provided based on the BLE method may include “ibeacon service”, “gimbal service” and the like.

The BLE may have about 40 channels formed in a bandwidth from 2.4 GHz to 2 MHz. According to an embodiment, an advertising channel may be 37, 38, and 39 channels, and remaining channels may be used in a data transmission.

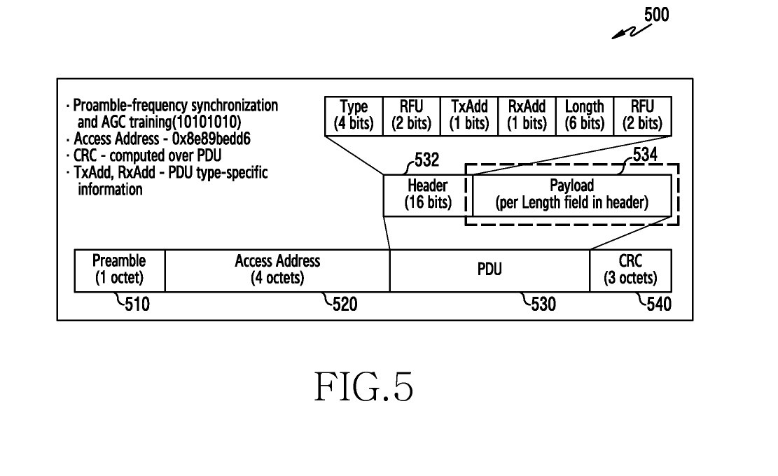

FIG. 5 is a diagram illustrating a configuration of an advertising packet, according to an embodiment of the present disclosure. Referring to FIG. 5, the advertising packet 500 may include a preamble 510, an access address 520, a Protocol Data Unit (PDU) 530, Cyclic Redundancy Check (CRC) 540 and the like. Here, the preamble 510 may include information for a frequency synchronization and an AGC training. According to an embodiment, the preamble may have the size of one octet, and the access address may have the size of four octets.

The PDU 530 may include a header 532 and a payload 534. According to an embodiment, the payload 534 may include 16 bits, and the bit number forming the payload may be determined based on a length field value of the header of the payload. For example, the header may include a type (e.g., 4 bits), a Reserved for Future Use (RFU) (e.g., 2 bits), TxAdd (e.g., 1 bit), RxAdd (e.g., 1 bit), a length (e.g., 6 bits), and the like.

A type field encoding of the header may be classified into 7 types, as shown in Table 1 below. For example, among the type field encoding of the header, ADV_IND, ADV_DIRECT_IND, ADV_NONCONN_IND and ADV_SCAN_IND may be classified as an advertising PDU, SCAN_REQ and SCAN_RSP may be classified as a scanning PDU, and CONNECT_REQ may be classified as an initiating PDU. A configuration of the payload may be changed according to each type. When a value of TxADD field and RxAdd field is 0, an address value may be normal, and when the value of TxADD field and RxAdd field is 1, the address value may be random.

TABLE 1

| PDU Type | Packet | | | | |
|---|---|---|---|---|---|
| b3b2b1b0 | Name | Description | Payload | | |
| | | | AdvA | AdvData | |
| 0000 | ADV_IND | connectable undirected advertising event | (6 octets) | (0-31 octets) | |
| | | | AdvA | InitA | |
| 0001 | ADV_DIRECT_IND | connectable directed advertising event | (6 octets) | (6 octets) | |
| | | | AdvA | AdvData | |
| 0010 | ADV_NONCONN_IND | non-connectable undirected advertising event | (6 octets) | (0-31 octets) | |
| | | | ScanA | AdvA | |
| 0011 | SCAN_REQ | sent by the Link Layer in the Scanning State, | (6 octets) | (6 octets) | |
| | | received by a Link Layer in the Advertising | | | |
| | | State | | | |
| | | | AdvA | ScanRspData | |
| 0100 | SCAN_RSP | sent by the Link Layer in the Advertising State, | (6 octets) | (0-31 octets) | |
| | | received by a Link Layer in the Scanning State | | | |
| | | | InitA | AdvA | LLData |
| 0101 | CONNECT_REQ | sent by the Link Layer in the Initiating State and | (6 octets) | (6 octets) | (22 octets) |
| | | received by the Link Layer in the Advertising | | | |
| | | State | | | |

| | | | AdvA | AdvData |
|---|---|---|---|---|
| 0110 | ADV_SCAN_IND | scannable undirected advertising event | (6 octets) | (0-31 octets) |
| 0111-1111 | Reserved | Reserved | | |

According to an embodiment, a payload of an ibeacon may include a mac address of an advertiser, ibeacon related information (e.g., an ibeacon identifier) indicating an ibeacon, a service identifier field, a major field, a minor field, and a transmission power field.

A UUID may be generated according to an RFC4122 standard, and may be used as an identifier identifying a service. According to an embodiment, an ibeacon transmitter installed in a building (e.g., Starbucks) may transmit a service identifier specifying Starbucks by including the service identifier in a service identifier field of the ibeacon. Therefore, a UE receiving the ibeacon transmitted from the ibeacon transmitter installed in the Starbucks may know that there is a Starbucks near the UE through the service identifier field of the ibeacon.

The transmission power field may indicate transmission power of the ibeacon transmitter. When the transmission power is compared with signal power in a case of an ibeacon reception, the distance from the ibeacon transmitter may be identified.

The UE receiving the ibeacon may perform an operation corresponding to a corresponding ibeacon. According to an embodiment, the UE may drive an application related to the ibeacon or communicate with another electronic device (e.g., a server) related to the ibeacon, and may receive efficient information (e.g., coupon information and the like).

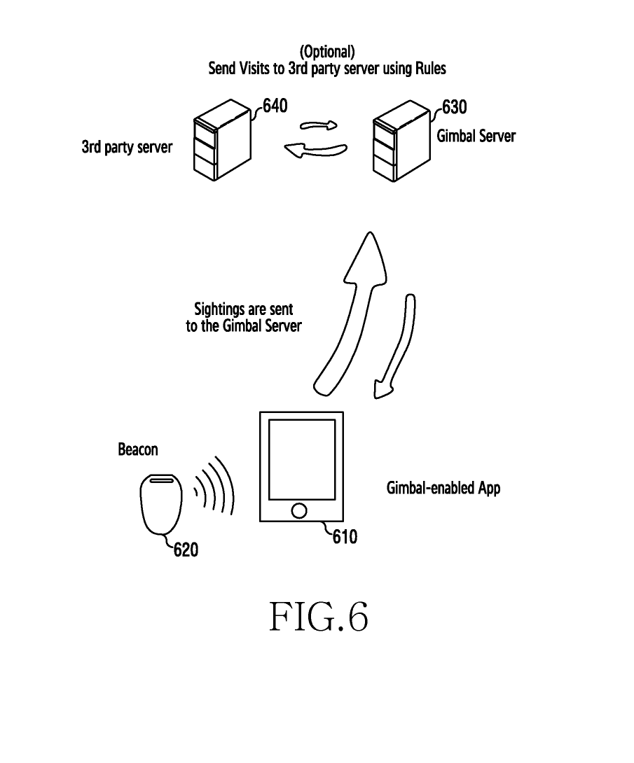

FIG. 6 is a diagram illustrating a network environment of a gimbal, which is a location based service method, according to an embodiment of the present disclosure.

Referring to FIG. 6, a gimbal service may be a technique based on a BLE and may be operated similarly to the above-mentioned ibeacon. According to an embodiment, a UE 610 receiving a gimbal beacon 620 may perform an operation corresponding to the received gimbal beacon 620, and may transfer the reception of the gimbal beacon 620 to a gimbal serve r 630. The gimbal server may provide this to a third party server 640.

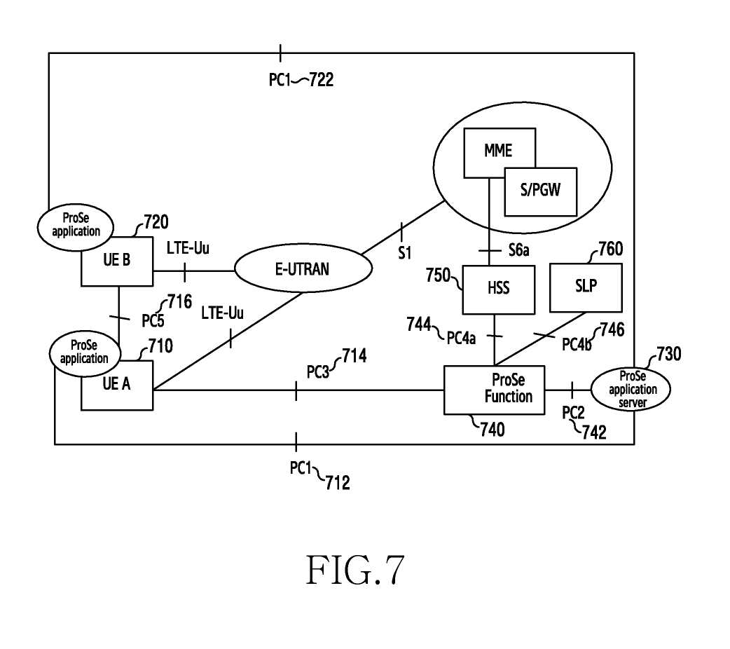

FIG. 7 is a diagram illustrating a network environment of a 3GPP among location based service methods, according to an embodiment of the present disclosure.

Referring to FIG. 7, a reference point between a UE A 710 or B 720 and a Proximity Server (ProSe) application server 730 may be PC1 712 or 722, a reference point between a ProSe function 740 and the ProSe application server 730 may be PC2 742, a reference point between the ProSe function 740 and the UE A 710 may be PC3 714, a reference point between the ProSe function 740 and a Home Subscriber Server (HSS) 750 may be PC4a 744, a reference point between the ProSe function 740 and a Service Location Protocol (SLP) 760 may be PC4b 746, and a reference point between the UE A 710 and the UE B 720 may be PC5 716.

According to an embodiment, a network may inform of whether the UE A and the UE B are adjacent to the UE. According to an embodiment, the UE may identify proximity or not using a ProSe application code transmitted and received through the PC5.

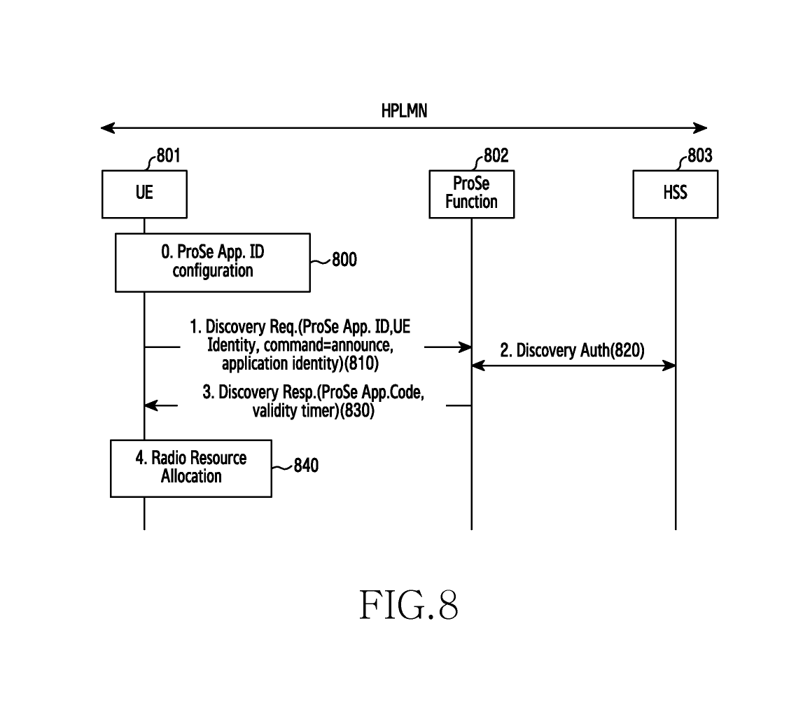

FIG. 8 is a diagram illustrating a procedure in which a ProSe application code is issued to a UE through a network in a situation in which the UE is located in a Home Public Land Mobile Network (HPLMN), according to an embodiment of the present disclosure.

Referring to FIG. 8, in step 800, a UE 801 performs a ProSe application identifier configuration. For example, the UE 801 may perform the ProSe application identifier configuration in a process of installing a ProSe application.

In step 810, the UE 801 transmits a discovery request message to a ProSe function 802. Here, the discovery request message may include the ProSe application identifier, UE attributes, an instruction, an announcement, and application attributes. The announcement may include information for identifying contents indicating that the UE 801 desires to make an announcement through a broadcasting.

In step 820, the ProSe function 802 may perform an authentication for the UE 801 transmitting the discovery request through an HSS 803 and a discovery auth process. When the authentication is performed, in step 803, the ProSe function 802 transmits a response to the discovery request to the UE 801 through a discovery response message.

Here, the discovery request message may include a ProSe application code and a validity timer. In step 840, the UE 801 transmits the ProSe application code through an allocated wireless resource.

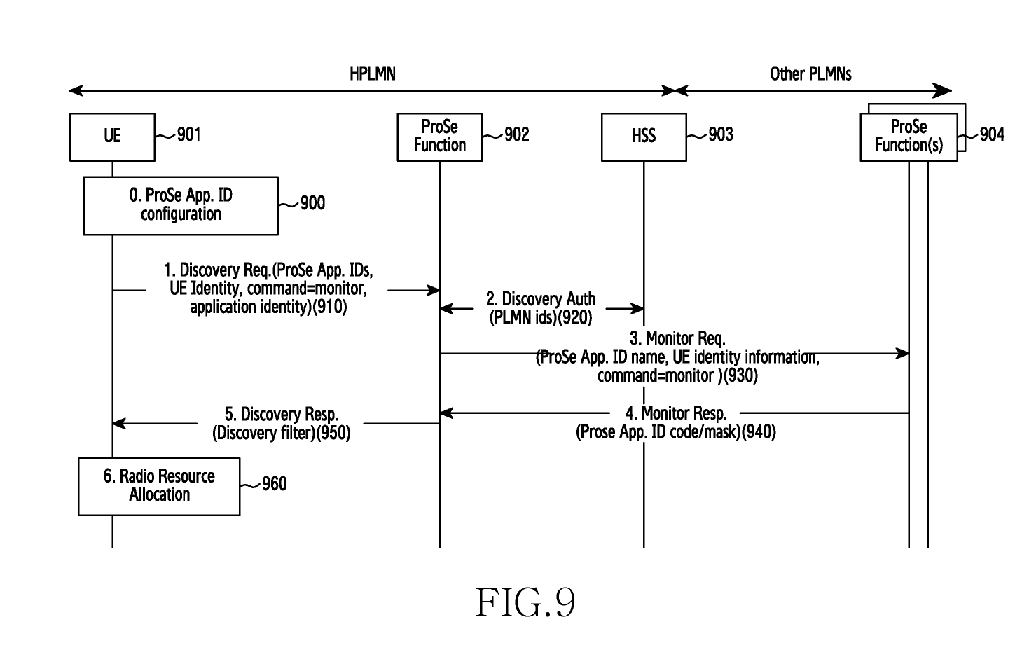

FIG. 9 is a diagram illustrating a procedure in which a UE requests a discovery filter to a network and receives from the discovery filter from the network, in order to monitor a ProSe application code in a situation in which the UE is located in an HPLMN, according to an embodiment of the present disclosure.

Referring to FIG. 9, in step 900, a UE 901 performs a ProSe application identifier configuration. For example, the UE 901 may perform the application identifier configuration in a process of activating a ProSe application.

In step 910, the UE 901 transmits a discovery request message to a ProSe function 902. Here, the discovery request message may include the ProSe application identifier, UE attributes, an instruction, a monitor, application attributes, and the like. The monitor may include information for identifying contents indicating that the UE 901 desires to perform a monitoring.

In step 920, the ProSe function 902 performs authentication for the UE 901 transmitting the discovery request through an HSS 903 and a discovery authentication process. In this operation, a PLMN id may be included. The PLMN id may include a Mobile Country Code (MCC) and a Mobile Network Code (MNC). The PLMN id may be changed in the discovery auth process.

In step 930, the ProSe function 902 transmits a monitor request to a ProSe function(s) 904 of another PLMN. In step 940, the ProSe function 902 receives a monitor response from the ProSe function(s) 904 of another PLMN. According to an embodiment, the ProSe function 902 may transmit the monitor request to the ProSe function(s) 904 of another PLMN and may not receive the monitor response according to a ProSe application identifier.

The monitor request may include a ProSe application identifier name, UE attributes information, a command, a monitor and the like.

In addition, the monitor response may include ProSe application identifier code/mask.

In step 950, the ProSe function 902 transmits a discovery filter to the UE 901 through the discovery response.

In step 960, the UE 901 monitors the ProSe application code through an allocated wireless resource.

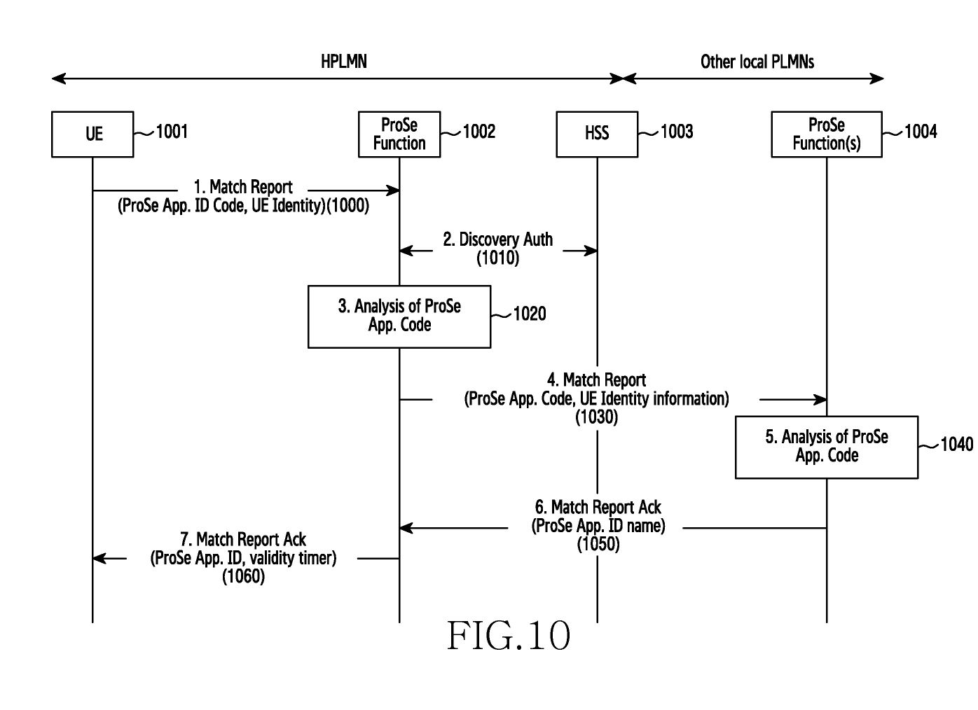

FIG. 10 is a diagram illustrating a procedure for identifying a ProSe application identifier, when the UE located to an HPLMN is matched to a discovery filter, but the ProSe application identifier is not stored in the UE, according to an embodiment of the present disclosure.

Referring to FIG. 10, in step 1000, a UE 1001 may transmit a match report to a ProSe function 1002. According to an embodiment, the match report may include a ProSe application identifier code, UE attributes, and the like.

In step 1010, the ProSe function 1002 performs a discovery authentication operation for an authentication process for an HSS 1003 and the UE 1001.

In step 1020, the ProSe function 1002 performs an analysis for a ProSe application code.

In step 1030, the ProSe function 1002 transmits the match report to a ProSe function(s) 1004 of another PLMN.

In step 1040, the ProSe function(s) 1004 of another PLMN analyzes the ProSe application code.

In step 1050, the ProSe function 1002 receives a match report ack according to a match report response from the ProSe function(s) 1004 of another PLMN.

According to various embodiments, step 1020 for performing the analysis for the ProSe application code, step 1030 for transmitting the match report to the ProSe function(s) 1004 of another PLMN, and step 1050 for receiving the match report ack may not be performed when the ProSe application code is part of the HPLMN, in step 1020 for performing the analysis for the ProSe application code.

Here, the match report may include information on the ProSe application code and the UE attributes.

In addition, the match report ack may include a ProSe application identifier name.

In step 1060, the ProSe function 1002 transmits the match report ack to the UE 1001. According to an embodiment, the match report ack may include the ProSe application identifier and a validity timer.

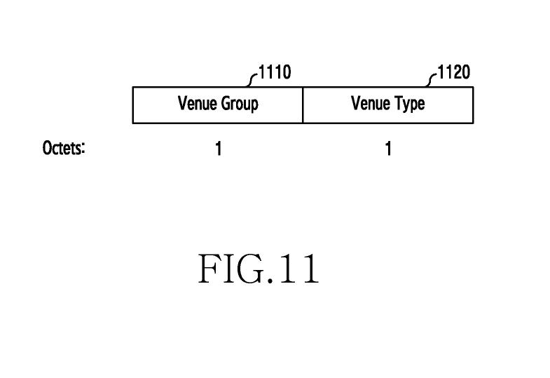

FIG. 11 is a diagram illustrating a configuration of a venue info field in IEEE 802.11u, according to an embodiment of the present disclosure. For example, in IEEE 802.11u, the venue info field may be included as management frame body components. The configuration may include a venue group (e.g., one octet) 1110 and a venue type (e.g., one octet) 1120, as shown in FIG. 11.

The defined venue group code may be determined as shown in Table 2.

TABLE 2

| Venue | |
|---|---|
| Group | Venue Group |
| Code | Description |
| 0 | Unspecified |
| 1 | Assembly |
| 2 | Business |
| 3 | Educational |
| 4 | Factory and Industrial |
| 5 | Institutional |
| 6 | Mercantile |
| 7 | Residential |
| 8 | Storage |
| 9 | Utility and Miscellaneous |
| 10 | Vehicular |
| 11 | Outdoor |
| 12-255 | Reserved |

According to an embodiment, the venue type may be defined according to each venue group code. For example, venue types such as an unspecified assembly (e.g., 0), an area (e.g., 1), a stadium (e.g., 2), a passenger terminal (e.g., 3), an amphitheater (e.g., 4), an amusement park (e.g., 5), a place of worship (e.g., 6), a convention center (e.g., 7), a library (e.g., 8), a museum (e.g., 9), a restaurant (e.g., 10), a theater (e.g., 11), a bar (e.g., 12), a coffee shop (e.g., 13), a zoo or an aquarium (e.g., 14), and an emergency coordination center (e.g., 15) may be defined in the venue group assembly.

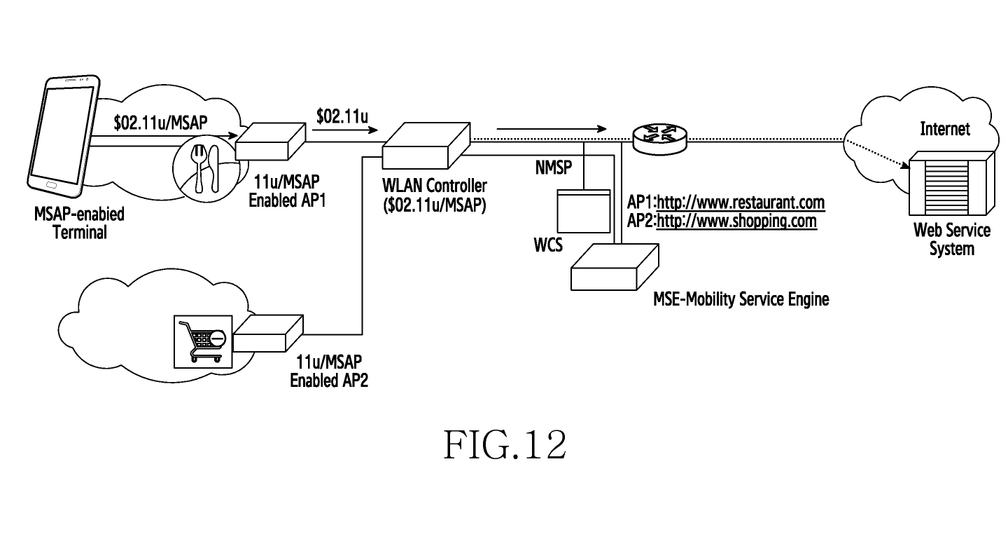

FIG. 12 is a diagram illustrating a network environment of a Mobility Services Advertising Protocol (MSAP) among location based service methods, according to an embodiment of the present disclosure.

Referring to FIG. 12, the MSAP is an IEEE 802.11u based protocol, and may be a structure for informing of a service (e.g., a restaurant, a shopping mall and the like) connected through a WLAN controller to surrounding UEs through an AP.

Hereinafter, a network environment of an ibeacon will be described as an example.

According to various embodiments, an electronic device (or a UE) may include a service management program for providing and managing various services through a location based service.

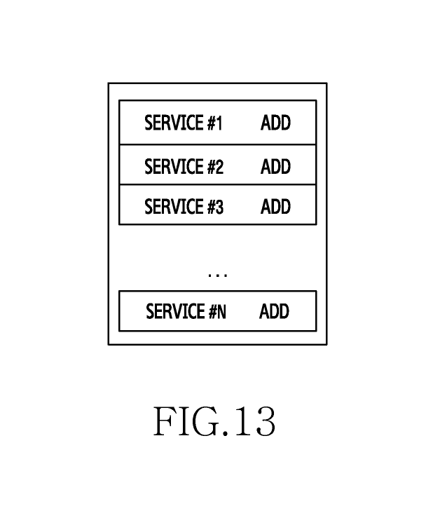

FIGS. 13 to 17 are diagrams illustrating a list configuration of a service displayed through a service management program, according to an embodiment of the present disclosure. As shown in FIG. 13, the electronic device may display the list of the service through the service management program. For example, when an add button for at least one service is selected by a user, the electronic device may activate a selected service.

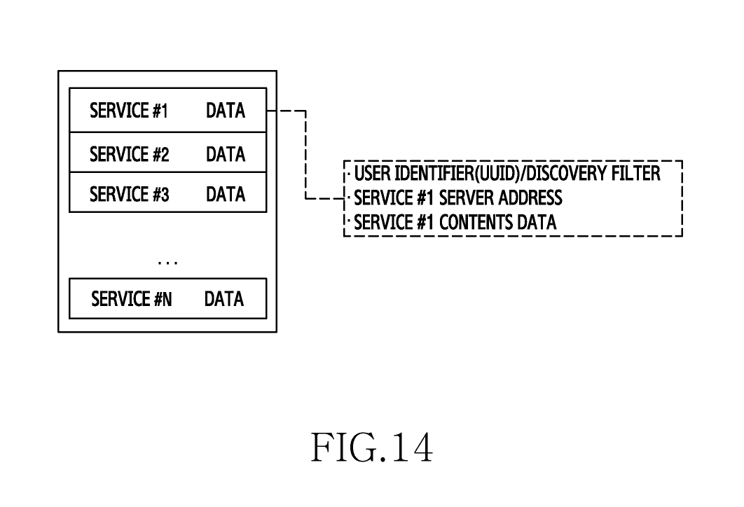

According to an embodiment, as shown in FIG. 14, the electronic device may configure at least one of service identifier (i.e., UUID)/discovery filter, a service server address, service contents related information (e.g., a contents stored position (e.g., an address)/contents themselves) of the service activated (i.e., registered) using the service add (or registration) button in a database.

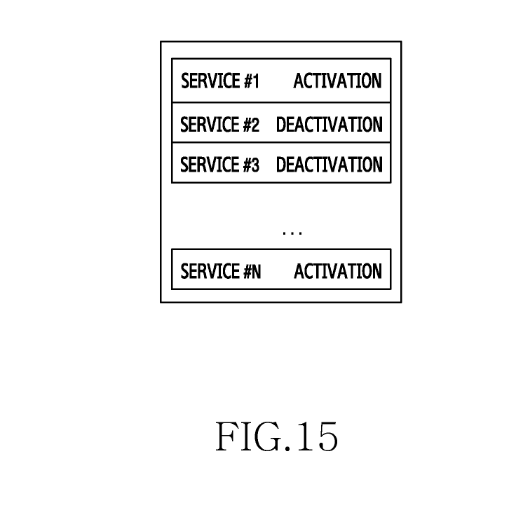

According to an embodiment, as shown in FIG. 15, the electronic device may control a notification for the activated service. For example, the notification for the activated service may be activated or deactivated based on a selection of the user for activation/deactivation buttons existed according to each service. According to an embodiment, the notification for the activated service may perform the activation or the deactivation temporarily, periodically or regularly.

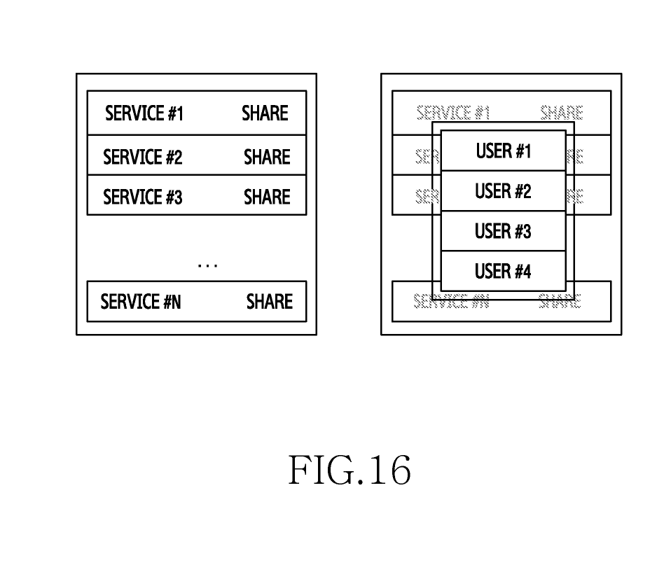

According to an embodiment, as shown in FIG. 16, the electronic device may provide the activated service, such that the activated service is shared with at least one external electronic device (i.e., at least one other user). For example, the electronic device may display a sharing menu by including a sharing button according to each service. When a selection of the user for the sharing button of at least one service is sensed, the electronic device may display a list of another user sharing a corresponding service. After the electronic device displays the list of another user, the electronic device may share the corresponding service with at least one another user based on the selection of the user.

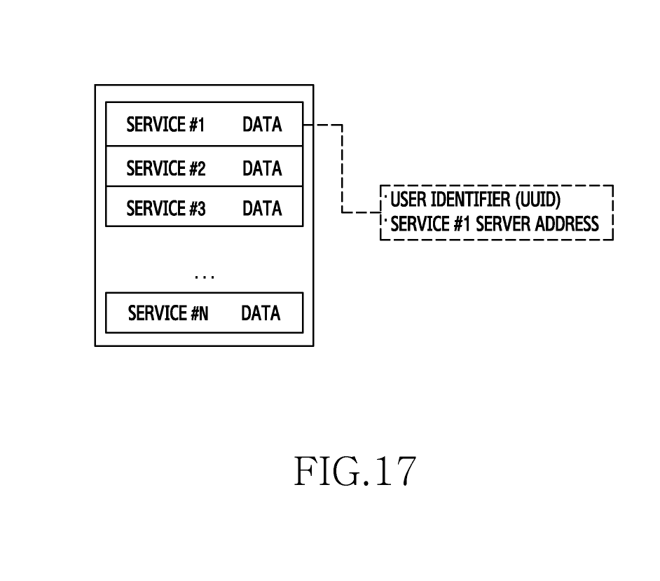

According to an embodiment, as shown in FIG. 17, the electronic device may register and manage of the service through a service management program server. For example, the electronic device may store each service identifier (i.e., UUID), service server addresses according to each service in a database.

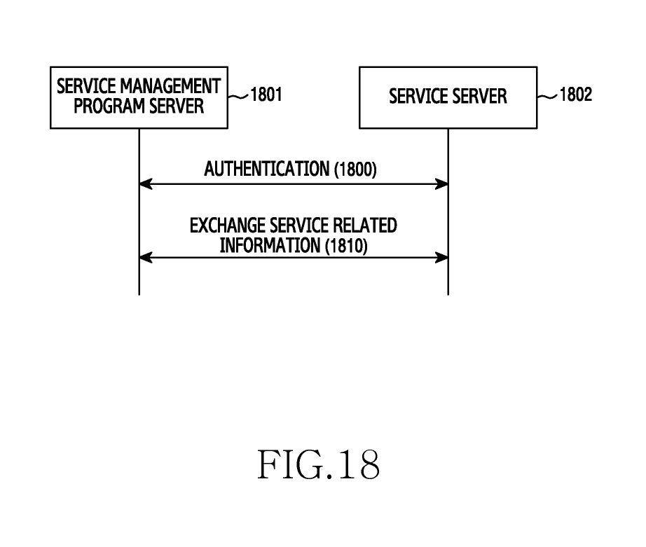

FIG. 18 is a diagram illustrating a procedure for exchanging service related information between a service management program server and a service server, according to an embodiment of the present disclosure. As shown in FIG. 18, a server 1802 of each service may register a service thereof in a service management program server 1801. For example, in step 1800, the service server 1802 performs an authentication process between the service server 1802 and the service management program server 1801. In step 1810, after the performance of the authentication process, the service server 1802 and the service management program server 1801 exchanges the service related information.

According to an embodiment, the service server 1802 may transfer a service identifier, a service server address and the like thereof to the service management program server 1801. For example, a user may also input directly the related information in a webpage of the service management program.

According to an embodiment, the service management program server 1801 may issue the service identifier to the service server 1802. For example, the service management program server 1801 may transfer the service identifier to the service server 1802, relate the transferred service identifier to the service, and store the related service identifier and service in a database.

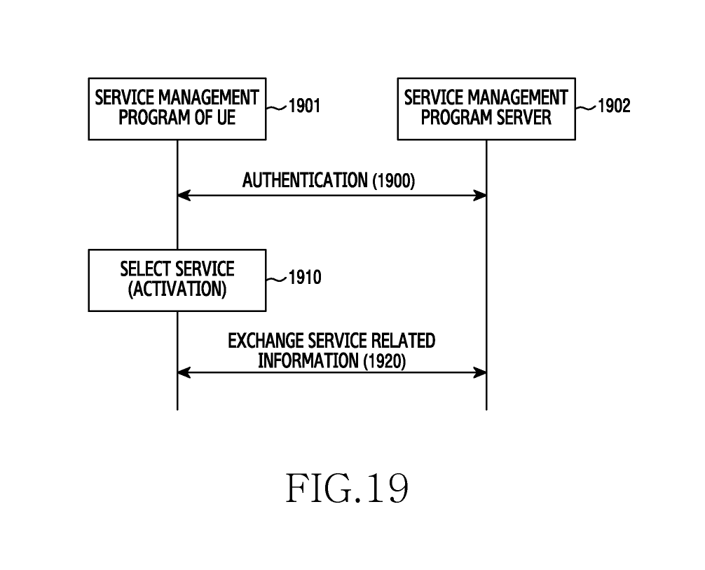

FIG. 19 is a diagram illustrating a procedure for exchanging service related information between a UE and a service management program server, according to an embodiment of the present disclosure. As shown in FIG. 19, in step 1900, the UE (e.g., the service management program 1901 of the UE) performs an authentication process between the UE and the service management program server 1902.

In step 1910, when a desired service is selected (e.g., activated) by the UE, in step 1920, the UE exchanges information related to the selected service with the service management program server 1902. For example, the UE may receive the information related to the selected service from the service management program server 1902 and store the information in a database. That is, the UE may receive a service identifier of the selected service, a service server address of the selected service, and the like from the service management program server 1902, and may store the service identifier of the selected service, the service server address of the selected service, and the like.

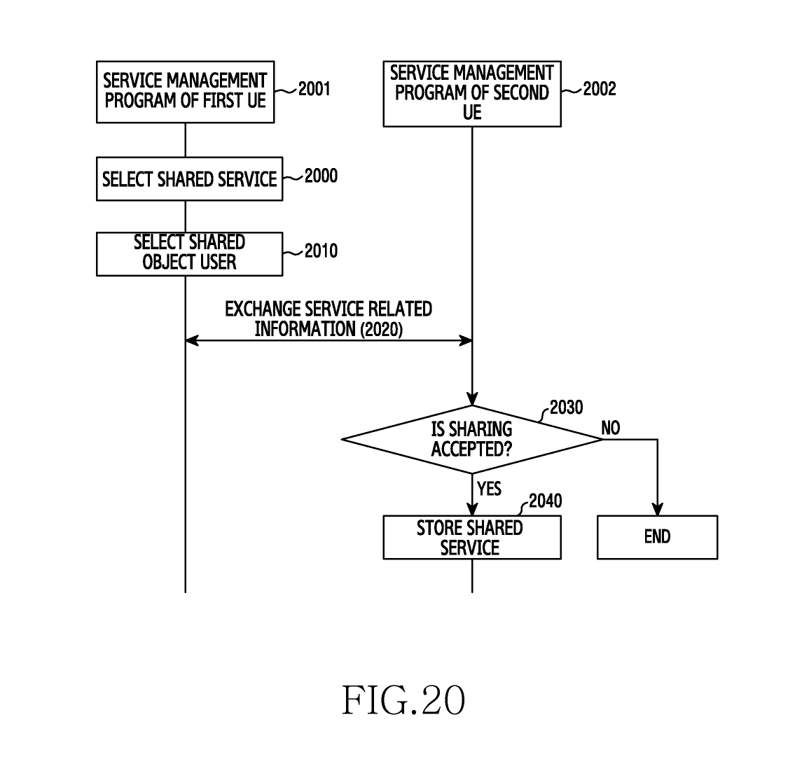

FIG. 20 is a diagram illustrating a procedure for sharing a service between a first UE and a second UE, according to an embodiment of the present disclosure. As shown in FIG. 20, the first UE may share a service desired to be shared with another second UE. According to an embodiment, in step 2000, a service management program 2001 of the first UE selects a service to be shared. in step 2010, the service management program 2001 of the first UE selects another user with which the selected shared service is shared.

In step 2020, the service management program 2001 of the first UE exchanges service related information with a service management program 2002 of the selected second UE. The service related information may be directly transferred between each UE. Alternatively, the service related information may be transferred to each UE from a service management program server by requesting corresponding service related information to the service management program server.

In step 2030, the service management program 2002 of the second UE determines whether the sharing for the shared service is accepted. In step 2040, the service management program 2002 of the second UE may store the shared service according to the sharing acceptance.

According to an embodiment, in a service management program (e.g., the service management program 2002 of the second UE) of a UE receiving the service related information, a UI asking whether a receiving user wishes to use a corresponding service may be displayed to the receiving user. When the receiving user selects the use of the corresponding service, the service related information may be stored in a database. For example, when the receiving user rejects the use of the corresponding service, the service related information may not be stored.

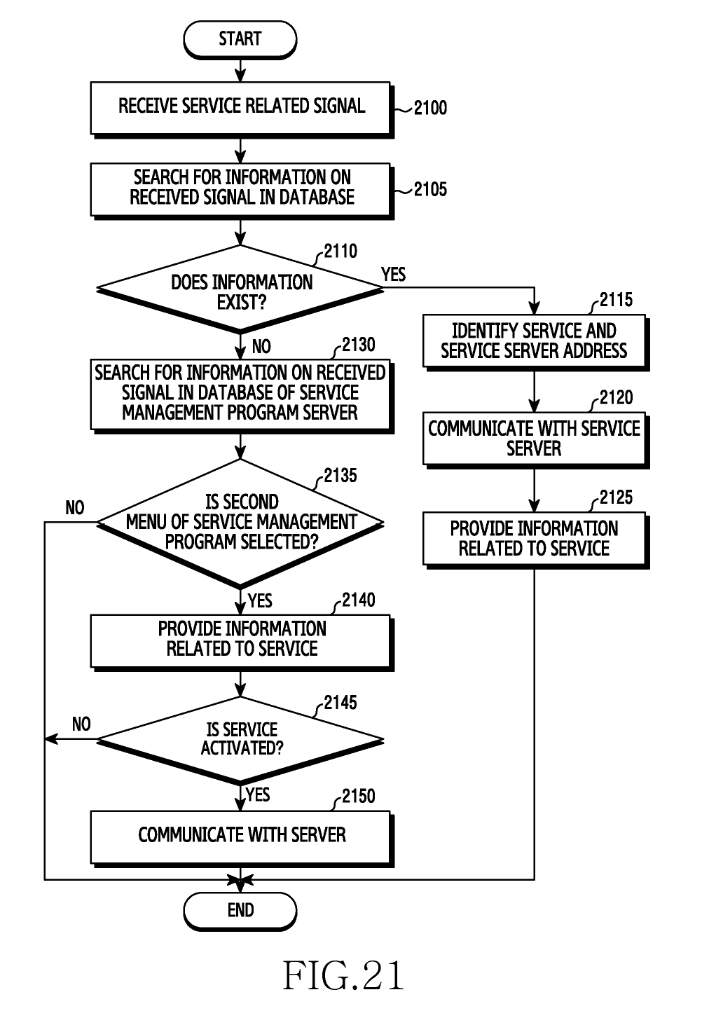

FIG. 21 is a flowchart illustrating a procedure for an operation method of a UE when a service related signal is received, according to an embodiment of the present disclosure. According to an embodiment, in step 2100, a UE receives a service related signal (e.g., a wireless signal, a beacon signal and the like) through a communication interface.

In step 2105, the UE searches for information (e.g., identification information, service identification information, coupon information, contents information and the like) for the received signal in a database stored in a memory.

In step 2110, the UE determines whether the sought information exists.

When the sought information exists in the database of the UE, in step 2115, the UE identifies a corresponding service type and a server address of the service.

In step 2120, the UE communicates with a service server. According to an embodiment, the UE may communicate with the service server through a communication interface using a server address of the identified service.

In step 2125, the UE receives information related to the service. According to an embodiment, the UE may obtain information (e.g., content) related to a corresponding service from the service server connected to communicate.

At this time, the UE may display the information related to the service in a service management program. For example, the service management program may include two types of menus. Each menu may configure a separate UI. For example, the menu may include a menu displaying a service used (or registered) by the user, or a menu displaying a service that is not used (or registered) by the user but is searched for (discovered or scanned) around the user.

When it is determined in step 2135 that the sought information does not exist in the database of the UE, the UE searches for information on a received signal in a database of a service management program server, in step 2130. According to an embodiment, the UE may transmit the information on the signal received through a communication interface to the service management program server. For example, the UE may be in a state connected to communicate with the service management program server. Here, the service management program server may identify a service corresponding to the signal by utilizing the information received from the UE, and may provide the identified service to the UE.

In step 2135, the UE determines whether a second menu of the service management program is selected. According to an embodiment, the UE may identify whether the above-mentioned second menu (e.g., a menu displaying a service searched around the UE) is selected by a user.

When the second menu of the service management program is selected, the UE receives the information related to the service, in step 2140. According to an embodiment, the UE may receive information on the service corresponding to a corresponding signal or the contents related to the corresponding signal, and the like from the service management program server.

In step 2145, the UE determines whether the corresponding service is activated. According to an embodiment, the UE may identify whether the service is activated based on at least one of an identifier of the service corresponding to the received wireless signal, a search filter and a server address. According to another embodiment, the UE may determine whether the service is activated based on a user input. For example, the UE may receive, from the user, an input of a selection for whether the user continuously uses the second menu from the user.

When the service is activated, the UE communicates with a server, in step 2150. According to an embodiment, the UE may perform a related operation based on the user input. For example, the UE may provide a service use (or registration) button. When an input of the user for the service use (or registration) button is detected, the UE may store information of a corresponding service in a database of the service management program, and may display the corresponding service in a menu that displays a service used (or registered) by the user later.

According to an embodiment, when the user does not click the use (registration) button and the UE detects the selection for a service portion, the UE may not store related information (i.e., may not use (or register) in the service management program) and may communicate with the service server to utilize the corresponding service one-shot manner.

When the second menu is not selected in step 2135, or when the service is not activated in step 2145, the methodology terminates.

According to various embodiments, a user of an electronic device may not need an installation of a separate application to receive a proximity service or a location based service.

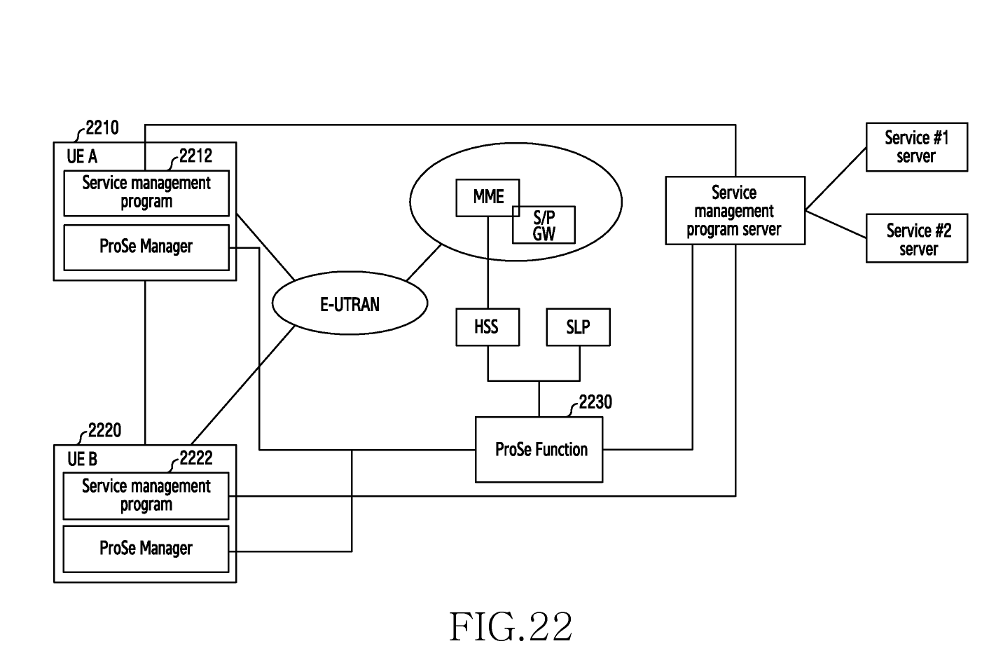

FIG. 22 is a diagram illustrating a network environment of a ProSe, according to an embodiment of the present disclosure. Referring to FIG. 22, a UE 2210 or 2222 may include a service management program 2212 or 2222 for providing and managing various services through a location based service. The service management program 2212 or 2222 may communicate with a ProSe function 2230.

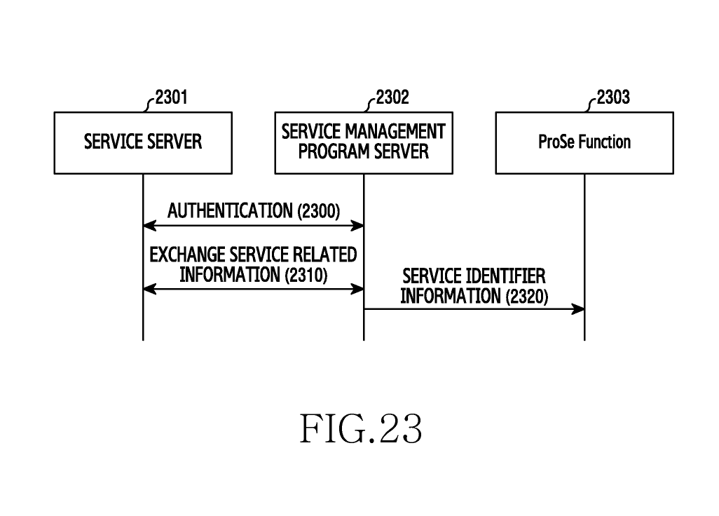

FIG. 23 is a diagram illustrating a procedure for transmitting service identifier information to a ProSe function from a service server through a service management program server, according to an embodiment of the present disclosure.

A server 2301 of each service may register a service thereof in a service management program server 2302.

In step 2300, the service server 2301 performs an authentication process between the service server 2301 and the service management program server 2302. In step 2310, after the performance of the authentication process, the service server 2301 and the service management program server 2302 exchange service related information.

In step 2320, the service management program server 2302 transfers a service identifier to a ProSe function 2303.

According to an embodiment, the service server 2301 may further transfer a service identifier (i.e., UUID) thereof, a service server address and the like to the service management program server 2302. For example, a user may also directly input the related information in a webpage of the service management program.

According to an embodiment, the service management program server 2302 may issue the service identifier to the service server 2301. For example, the service management program server 2302 may transfer the service identifier to the service server 2301, relate the transferred service identifier to the service, and store the related service identifier and service in a database.

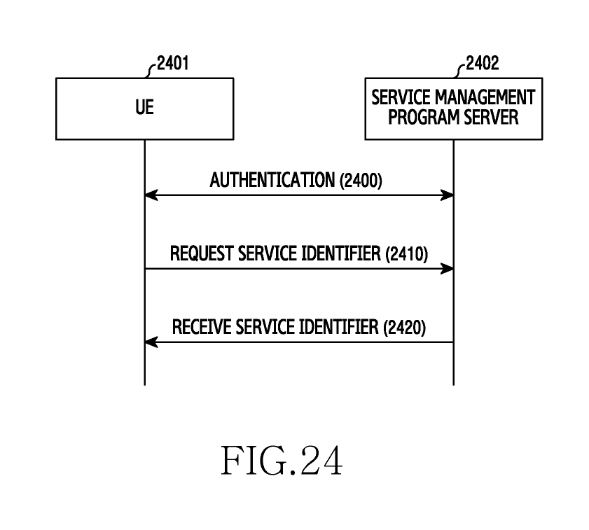

FIG. 24 is a diagram illustrating a procedure for receiving a service identifier from a service management program server in a UE, according to an embodiment of the present disclosure.

Referring to FIG. 24, in step 2400, a UE 2401 and a service management program server 2402 perform authentication through a communication interface.

In step 2410, the UE 2401 requests the service identifier to the service management program server 2402 through the communication interface.

In step 2420, the UE 2401 receives the service identifier from the service management program server 2402.

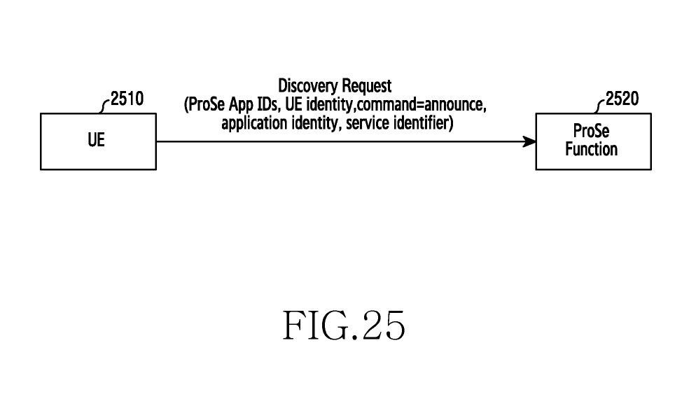

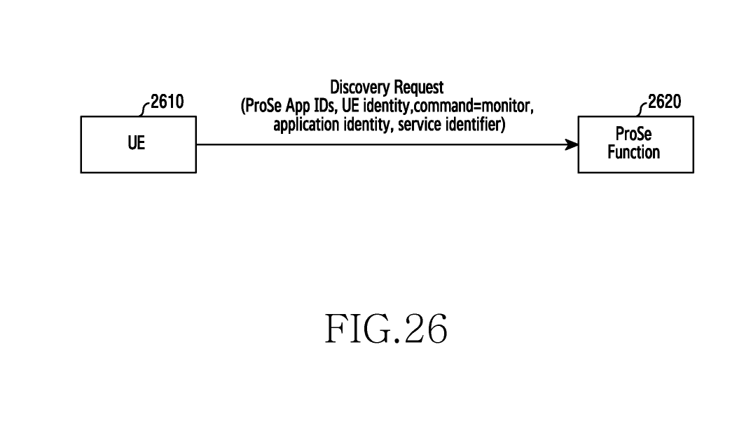

FIG. 25 and FIG. 26 are diagrams illustrating a procedure for transmitting a discovery request from a UE to a ProSe function, according to an embodiment of the present disclosure. According to an embodiment, as shown in FIG. 25, when a UE 2510 is a terminal of a service provider, the UE 2510 transfers a discovery request requesting a ProSe application code to a ProSe function 2520. The UE 2510 may transfer a service identifier, a ProSe app ID, a UE identifier and the like by including the service identifier, the ProSe app ID, the UE identifier and the like in the discovery request. For example, the ProSe app ID may correspond to a service management program ID.

According to an embodiment, as shown in FIG. 26, when the UE 2610 is a UE utilizing a service, the UE 2610 transfers a discovery request requesting a discovery filter to the ProSe function 2620. At this time, the UE 2610 may transfer a service identifier, a ProSe app ID, a UE identifier and the like by including the service identifier, the ProSe app ID, the UE identifier and the like in the discovery request.

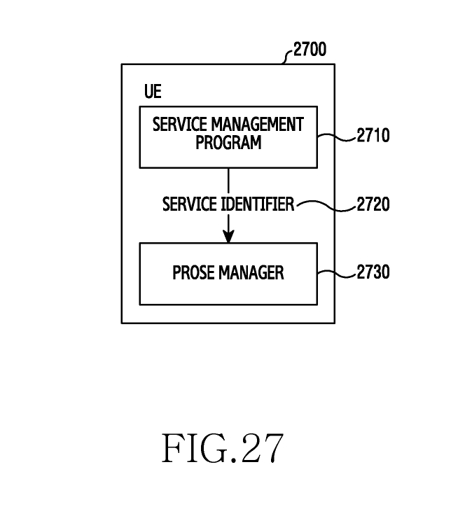

FIG. 27 is a diagram illustrating a configuration of a UE, according to an embodiment of the present disclosure. Referring to FIG. 27, the UE 2700 may include a service management program 2710 and a ProSe manager 2730. According to an embodiment, the service management program 2710 of the UE 2700 transfers a service identifier 2720 to the ProSe manager 2730. For example, the service management program 2710 may provide the service identifier 2720 included in a wireless signal received through a communication interface to the ProSe manager 2730.

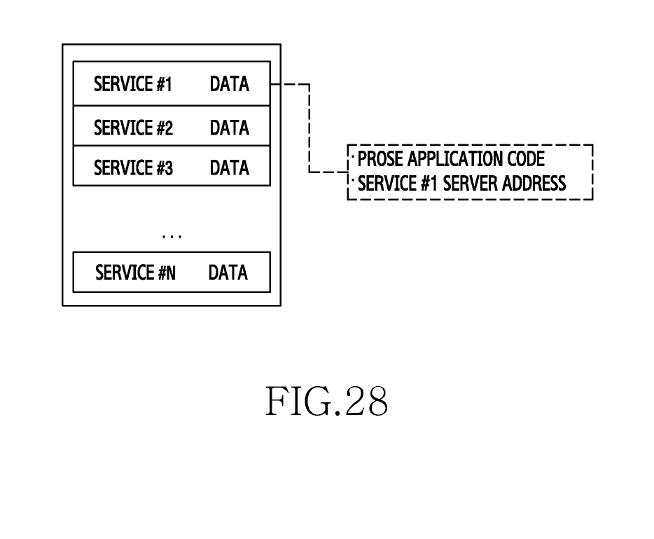

FIG. 28 is a diagram illustrating a list configuration of a service displayed through a service management program in a UE, according to an embodiment of the present disclosure. Referring to FIG. 28, the UE may store a ProSe application code, a discovery filter and the like in a database of the service management program. In addition, after the UE receives a service server address from the service management program, the UE may relate the service server address with a corresponding service and store the service server address.

According to various embodiments, an overall operation of a ProSe may be performed in the same manner as the operation described in the ibeacon. In addition, a server of the service management program may store a ProSe application code according to each service.

According to various embodiments, an electronic device may not transfer an unnecessary notification to the user.

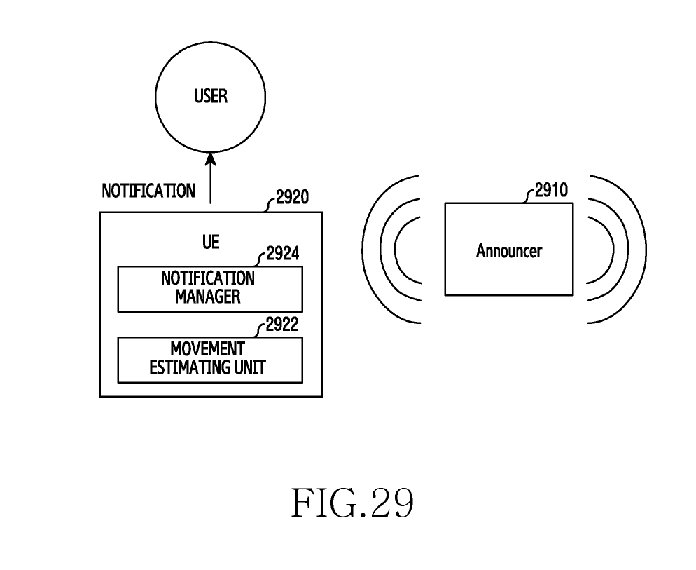

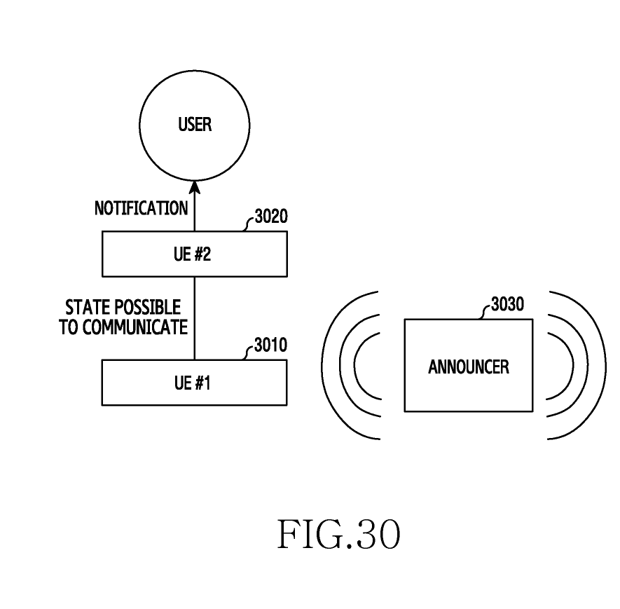

FIG. 29 and FIG. 30 are diagrams illustrating a procedure for transferring an announcement to a user, according to an embodiment of the present disclosure. Referring to FIG. 29, an announcer 2910 informs of an existence of the UE 2920 around the UE 2920. A method of informing of the existence by the announcer 2910 may include a method of using an announcement. An announcement method may be slightly different according to the above-described communication techniques. The announcement method may include, for example, an ibeacon, a gimbal beacon, a ProSe application code, an MASP beacon and the like.

According to an embodiment, an electronic device may receive the announcement through a communication interface and may interpret the announcement. Here, the communication interface may be different according to the above-described communication techniques.

According to an embodiment, a UE 2920 may include a movement estimating unit 2922 and a notification manager 2924. The movement estimating unit 2922 may estimate a movement of a user (or a movement of the UE 2920), and the notification manager 2924 may provide a notification to the user based on the estimated movement of the user. For example, the notification manager 2924 may transfer (e.g., notify) the announcement received through the communication interface to the user. Here, a method of transferring the announcement to the user may use at least one of a display, a sound, a vibration and a touch sensation.

FIG. 30 illustrates a case involving a plurality of UEs. For example, a UE #1 may be a smart phone of a user, a tablet PC, and the like, and a UE #2 may be various wearable devices (e.g., a smart watch, an HMD, and the like).

According to an embodiment, the UE #1 3010 and the UE #2 3020 may communicate with each other. For example, the UE #1 3010 and the UE #2 3020 may perform short range communication. The UE #1 3010 and the UE #2 3020 may be connected through various communication methods, such as, for example, BLE, BT, Wi-Fi, and D2D methods.

According to an embodiment, the UE #1 3010 may receive an announcement of an announcer 3030 around the UE #1 3010 through a communication interface, and may interpret the announcement. According to an embodiment, the UE #2 3020 may receive information related to the announcement from the UE #1 3010, and may transfer the information to the user.

According to an embodiment, the above-described movement estimating unit 2922 may be included in both of the UE #1 3010 and the UE #2 3020. For example, the movement estimating unit 2922 may exchange output information of the movement estimating unit 2922 using communication between the UE #1 3010 and the UE #2 3020.

According to an embodiment, when the above-described notification manager 2924 is included in the UE #1 3010, if the UE #1 3010 determines that the notification is necessary for the user, the UE #1 3010 may transfer a corresponding notification to the UE #2 3020.

According to an embodiment, when the above-described notification manager 2924 is included in the UE #2 3020, the UE #1 3010 may inform of the interpreted announcement to the UE #2 3020, and the UE #2 3020 may notify the announcement to the user.

According to an embodiment, the movement estimating unit may estimate the movement of the user using an acceleration sensor, a gyro sensor, and the like. In addition, the movement estimating unit 2922 may estimate the movement of the user using a location identifying module (e.g., a GPS, a WPS, a PDR and the like). In addition, the movement estimating unit may receive movement estimating information from the UE #2 3020 connected with the UE #1 3010.

For example, when a UE is connected to a vehicle, the UE may estimate the movement of the user by utilizing location identifying module information of the vehicle. Alternatively, the UE may estimate the movement of the user by using type information of another UE connected to the UE.

According to an embodiment, the notification manager of the UE may include a function for activating or deactivating a filter.

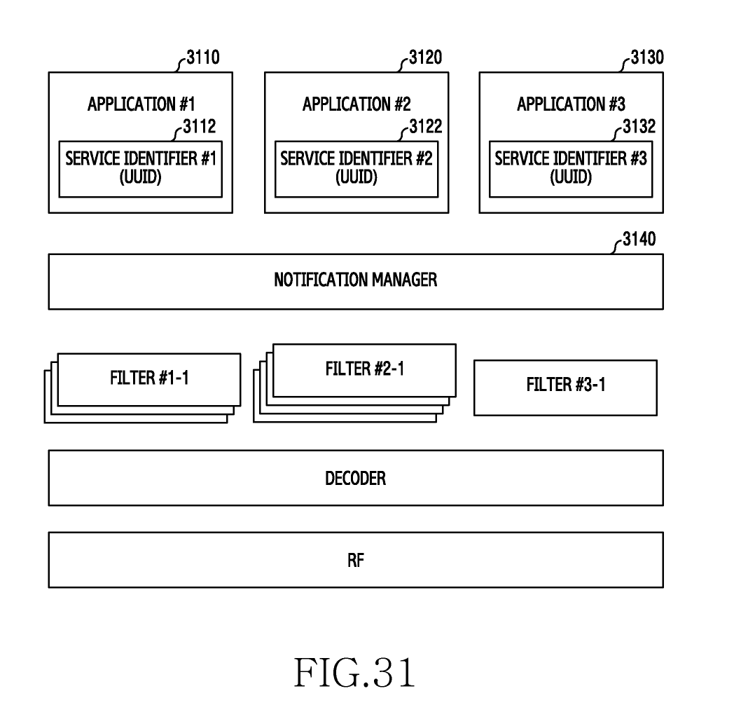

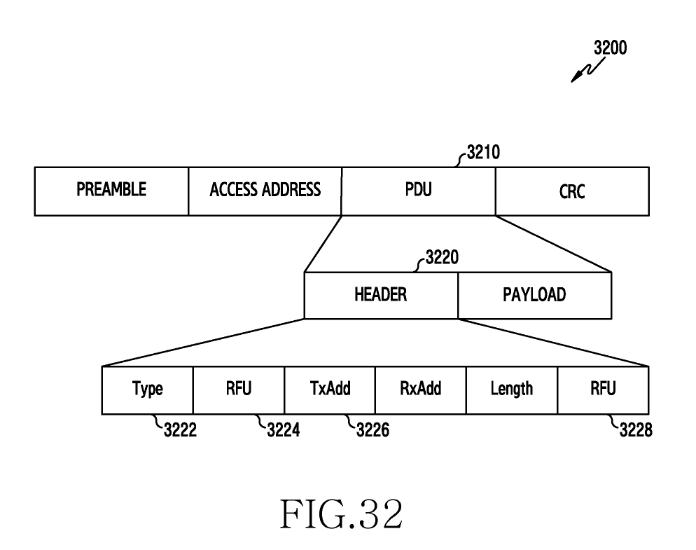

FIG. 31 is a diagram illustrating a block configuration of a UE, according to an embodiment of the present disclosure. FIG. 32 is a diagram illustrating a configuration of an advertising packet, according to an embodiment of the present disclosure.

Referring to FIG. 31, applications (e.g., application #1 3110, application #2 3120, application #3 3130, and the like) of the UE may have a service identifier list (i.e., service identifier #1 3112, service identifier #2 3122, service identifier #3 3132) announced by an announcer of a corresponding application. The applications may register the service identifier list through a filter, and may execute the application when an announcement corresponding to the application is received.

According to an embodiment, a notification manager 3140 may activate or deactivate the above-described filter. For example, in a case of a ProSe, the notification manager 3140 may activate or deactivate a discovery filter transferred from a ProSe function.

According to an embodiment, an ibeacon and a gimbal may be based on a BLE, and the BLE may have an advertising packet 3200 configuration as shown in FIG. 32. According to an embodiment, for an RFU 3224 or 3228, two (2) bits between a type 3222 and Txadd 3226 in a header 3220 of a PDU 3210 and two (2) bits at the last of the header 3220 of the PDU 3210 may be empty.

According to an embodiment, information informing of only whether an announcer device is mobile or fixed may be included in one (1) bit. Alternatively, information on mobility may be announced by utilizing a few more bits. For example, the mobility announced according to the number of bits may be configured as shown in Table 3 below.

TABLE 3

| 00 | 01 | 10 | 11 |
|---|---|---|---|
| Fixed | Low Mobility | Mid Mobility | High Mobility |
| (Stationary) | (Walking) | (Running) | (Driving) |

A movement of a UE or a device that announces the advertising packet of the BLE may be estimated through the configuration of Table 3.

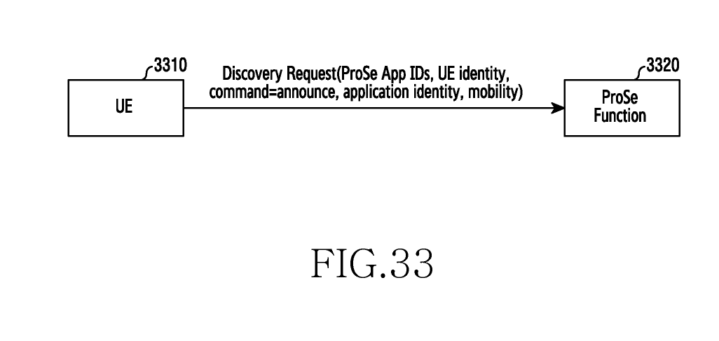

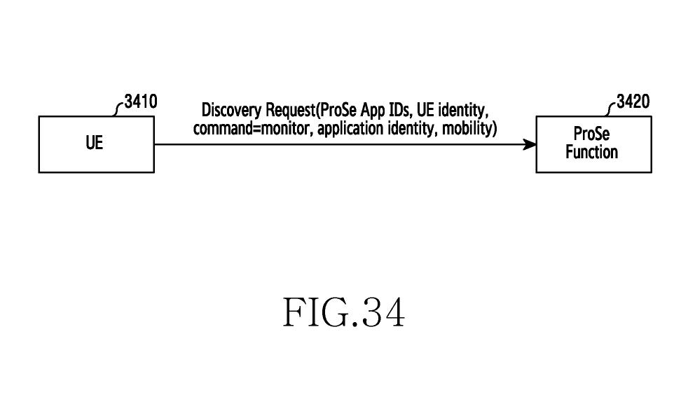

FIG. 33 and FIG. 34 are diagrams illustrating a procedure for transmitting a discovery request from a UE to a ProSe function, according to an embodiment of the present disclosure. Referring to FIG. 33, in a case of a ProSe, the UE 3310 transmits the discovery request including mobility information to the ProSe function 3320. Here, the discovery request may further include a ProSe app ID, a UE identifier, an application identifier, and the like.

According to an embodiment, a UE 3310 that attempts to announce may transmit a discovery request including mobility information of the UE 3310 to the ProSe function 3320, and the ProSe function 3320 may transmit a ProSe application code to the UE 3310 in response to the discovery request.

Referring to FIG. 34, the UE 3410 transmits the discovery request including mobility information to the ProSe function 3420. Here, the discovery request may further include a ProSe app ID, a UE identifier, an application identifier, and the like.

According to an embodiment, a UE 3410 that attempts to monitor may transmit a discovery request including mobility information of the UE 3410 or a concerned object to the ProSe function 3420, and the ProSe function 3420 may transmit a ProSe discovery filter to the UE 3410 in response to the discovery request.

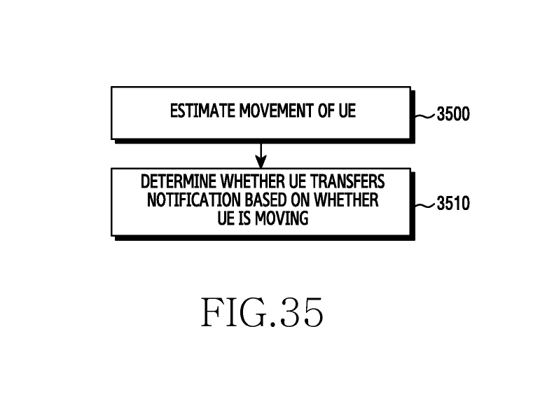

FIG. 35 is a flowchart illustrating a procedure for determining whether a UE transfers a notification based on whether a UE is moving, according to an embodiment of the present disclosure. Referring to FIG. 35, in step 3500, the UE estimates a movement of the UE. According to an embodiment, the UE may estimate a mobility of the UE using an acceleration sensor, a gyro sensor, or a location identifying module (e.g., a GPS, a WPS, a PDR, and the like).

In step 3510, the UE determines whether the UE transfers the notification based on whether the UE is moving. According to an embodiment, when the estimated mobility is greater than or equal to a critical value, the UE may transfer the notification, and when the estimated mobility is less than the critical value, the UE may not transfer the notification. For example, when a user moves by a car, the UE may not transfer the notification, and when the user walks, the UE may transfer the notification.

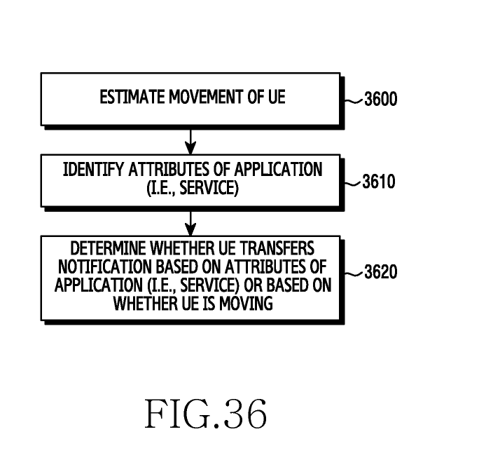

FIG. 36 is a flowchart illustrating a procedure for determining whether a UE transfers a notification based on attributes of an application or whether the UE moves, according to an embodiment of the present disclosure. Referring to FIG. 36, in step 3600, the UE estimates a movement of the UE. According to an embodiment, the UE may estimate a mobility of the UE using an acceleration sensor, a gyro sensor, or a location identifying module (e.g., a GPS, a WPS, a PDR, and the like).

In step 3610, the UE identifies attributes of an application (i.e., service). For example, the UE may identify a mobility, an importance, a priority, a service type, and the like of the application.

In step 3620, the UE determines whether the UE transfers the notification based on the attributes of the application or whether the UE moves. According to an embodiment, when the estimated mobility is greater than or equal to a critical value, the UE may transfer the notification, and when the estimated mobility is less than the critical value, the UE may not transfer the notification.

According to an embodiment, the UE may provide an application related to an announcement received through a communication interface to a user regardless of the mobility of the user. For example, the UE may transfer the notification to the user when the importance of a corresponding application is high or the priority of the application is high.

For example, while two people move in the same car, one person may activate an application (i.e., service). For example, the application (i.e., service) may include a (short range) chatting, a (short range) file sharing application (i.e., a (short range) file sharing service), a location sharing and the like. In the above case, a mobility of a counterpart may also be considered.

According to various embodiments, the UE may provide only information necessary for the user.

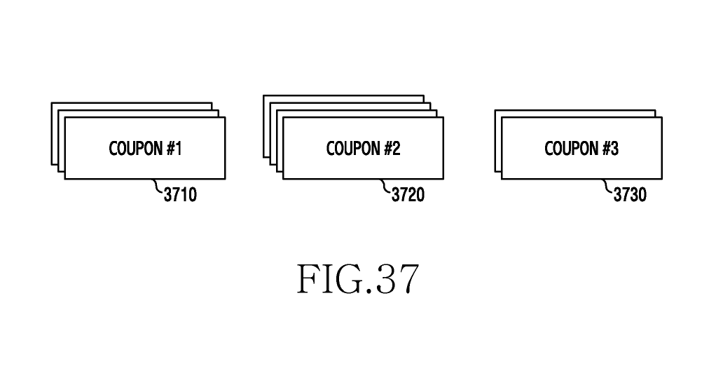

FIGS. 37 to 40 are diagrams illustrating a coupon list configuration, according to an embodiment of the present disclosure. Referring to FIG. 37, a service provider may provide various coupons (e.g., coupon #1 3710, coupon #2 3720, and coupon #3 3730) related to a service to a user. For example, a different coupon may be included according to each promotion. The coupons may include a contents identifier for distinguishing each coupon.

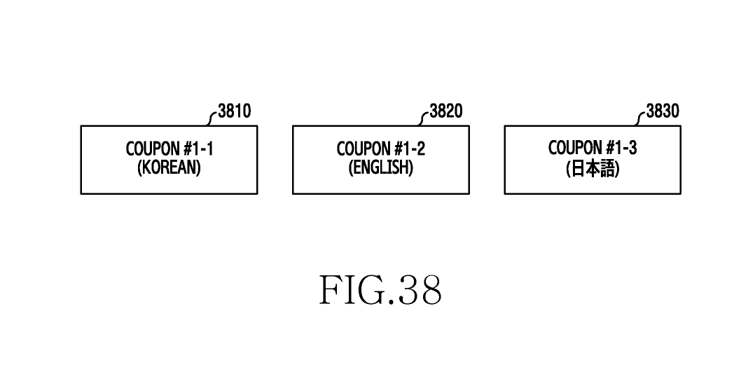

According to an embodiment, as shown in FIG. 38, the coupon may be divided according to a language type. Coupon #1 3710 shown in FIG. 37 may include three types. For example, coupon #1-1 3810 is a Korean text or Korean image coupon, coupon #1-2 3820 is an English text or English image coupon, and coupon #1-3 3830 is a Japanese text or Japanese image coupon.

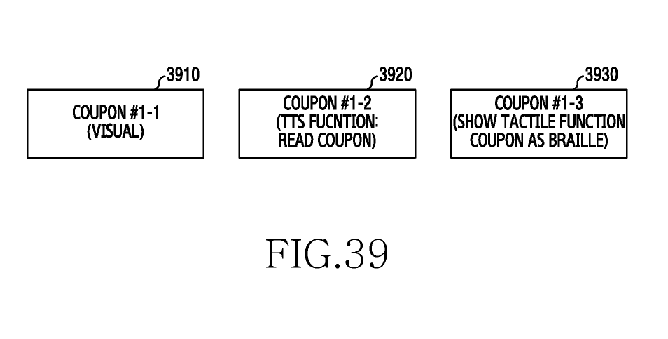

According to an embodiment, as shown in FIG. 39, the coupon may be divided according to a coupon providing method. For example, coupon #1-1 3910 is a visual coupon that does not have a special function, coupon #1-2 3920 is a coupon having a Text To Speech (TTS) function, and coupon #1-3 3930 is a coupon having a tactile function.

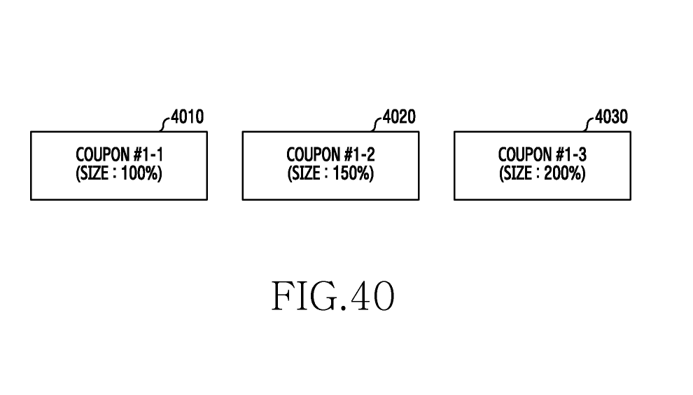

According to an embodiment, as shown in FIG. 40, the coupon may be divided according to a size of a coupon image. For example, coupon #1-1 4010 is a coupon of a basic size, coupon #1-2 4020 is a coupon shown in an expanded type about 1.5 times compared to the coupon #1-1 4010, and coupon #1-3 4030 is a coupon shown in an expanded type about 2 times compared to the coupon #1-1 4010. But, the coupons are not limited thereto, and the coupons may be divided according to various standards.

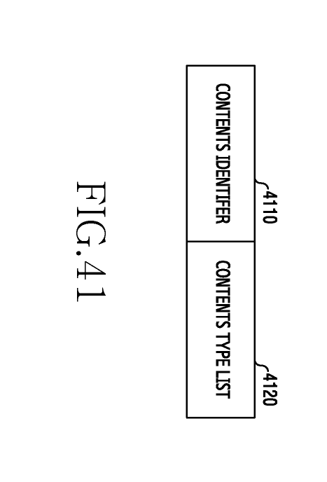

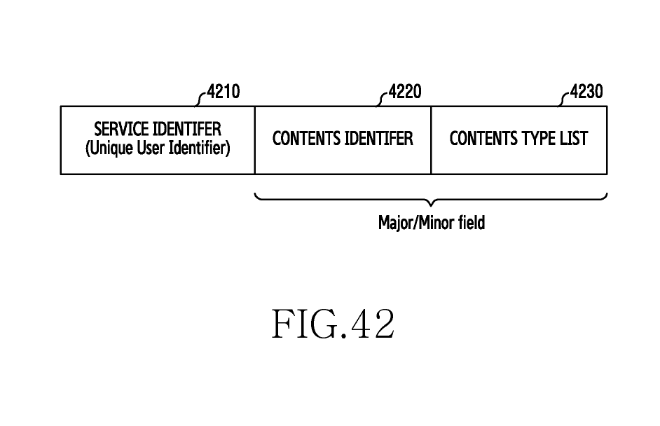

FIG. 41 and FIG. 42 are diagrams illustrating a configuration of an application (i.e., service), according to an embodiment of the present disclosure.

Referring to FIG. 41, the application (i.e., service) includes a content identifier 4110 and a content type list 4120.

According to an embodiment, the content type list 4120 may include information on a type (e.g., a language, an expression method, and the like) of contents provided to a user. For example, the contents type list 4120 may be configured in a bit map type.

According to an embodiment, Table 4 shows a language list in the bit map type as an example of the content type list 4120 (e.g., a language). Other types (e.g., a sense of sight, a sense of hearing, a sense of touch, a size, and the like) may be configured in the bit map type as shown in Table 4.

TABLE 4

| KR | EN | JP | CN | SP | FR | DE | RU |
|---|---|---|---|---|---|---|---|
| 1 | 1 | 1 | 0 | 0 | 0 | 0 | 0 |

According to an embodiment, a plurality of content type list 4120 may be included in one service or application.

According to an embodiment, the type identifier may determine whether a bit map is a provision language bit map or an expression method bit map. For example, as shown in Table 5, a bit map string following a type identifier 0x00 may be a language information bit map string, and a bit map string following a type identifier 0x01 may be an expression method (e.g., a sense of sight, a sense of hearing, a sense of touch, and the like) bit map string. When the length of the bit map string is variable, information on the length of the bit map may be included after the type identifier. For example, when the type identifier corresponds to Table 5, Korean, English and Japanese contents may be provided as visual contents, TTS possible contents and tactile function possible contents, respectively. A type list length is not included after a second type identifier, and this may be an omitted case because this is an identifier of which a bit map string length is fixed as 3 bits for the expression method (e.g., 0x01).

TABLE 5

| | Type | | | |
|---|---|---|---|---|
| Type | list | | Type | |
| identifer | length | Type list | identifer | Type list |
| 0 × 00 | 8 | 11100000 | 0 × 01 | 111 |

According to an embodiment, the type identifier may be a type shown in Table 6. For example, Korean content may provide all of visual content, TTS possible content, and tactile function possible content, English content may provide the visual content and the TTS possible content, and a Japanese content may provide only the visual content. In addition, Chinese, Spanish, French, Germany, and Russian content may not be provided.

TABLE 6

| KR | | EN | | JP | | CN | | SP | | FR | | DE | | RU | |
|---|---|---|---|---|---|---|---|---|---|---|---|---|---|---|---|
| 1 | 111 | 1 | 110 | 1 | 100 | 0 | 000 | 0 | 000 | 0 | 000 | 0 | 000 | 0 | 000 |

In addition, information on the type identifier may be configured in a code type, a string or a natural language type rather than the bit map type, and may be transferred.

In addition, the above-described configuration type may be different according to each application or service.

According to an embodiment, the content identifier 4110 and the content type list 4120 may be configured in a type shown in FIG. 41. The content identifier 4110 and the content type list 4120 may be transferred through the above-described techniques (e.g., ibeacon, gimbal, ProSe, IEEE802.11u, MSAP, IEEE802.11aq, IEEE802.15.8, etc.) and techniques corresponding to the above-described techniques.

According to an embodiment, in a case of an ibeacon, the content identifier 4220 and the content type list 4230 may be included in a portion or a whole of major and minor fields after the service identifier 4210, as shown in FIG. 42. A configuration of the main and minor fields of the application (i.e., the service) is determined through the service identifier 4210, and the main and minor fields may be interpreted according to the configuration. For example, a UE receiving the ibeacon may determine the application or the service through the service identifier 4210. The determined application (i.e., determined service) may be executed in the UE. Thus, the content identifier 4220 and the content type list 4230 may be interpreted in the application (i.e., the service).

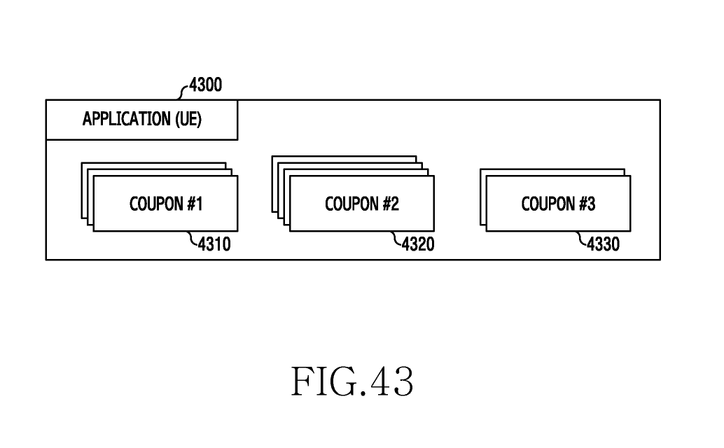

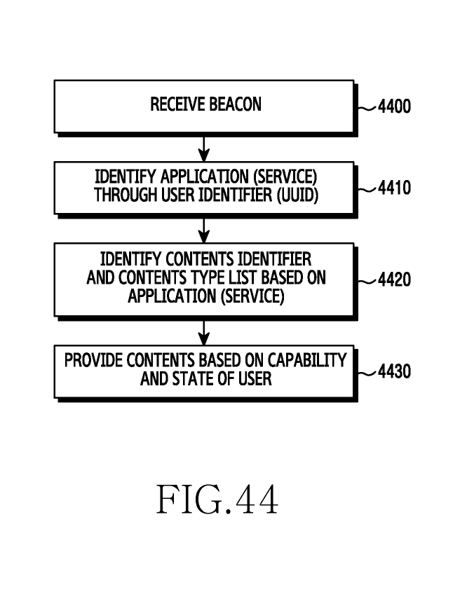

FIG. 43 is a diagram illustrating a configuration of an application having a plurality of pieces of content included in a UE, according to an embodiment of the present disclosure. FIG. 44 is a flowchart illustrating a procedure for providing content based on a capability of a user and a UE state, according to an embodiment of the present disclosure.

Referring to FIG. 43 and FIG. 44, when all pieces of content (e.g., a coupon #1 4310, coupon #2 4320, coupon #3 4330) are included in an application 4300 (i.e., a service) stored in a UE, the UE receives a beacon (i.e., a wireless signal), in step 4400. According to an embodiment, the UE may obtain the beacon signal through a communication interface.

In step 4410, the UE identifies the application 4300 (i.e., service) through a user identifier. According to an embodiment, the UE may identify a type, attributes, and the like, of the application through the user identifier.

In step 4420, the UE identifies the content identifier and the content type list based on the application 4300 (i.e., service). According to an embodiment, the UE identifies a size, a used language, a provision method, and the like of corresponding pieces of content through the content identifier and the content type list included in the application 4300.

In step 4430, the UE provides the content based on the capability of the user and the UE state. According to an embodiment, when the UE receives the beacon signal, the UE may select a proper item among the content identifier and the content type list interpreted in the received beacon signal to execute corresponding contents.

According to an embodiment, the UE may select and execute proper content (e.g., a coupon) based on the capability (e.g., a used language, a disability or ability, an age and the like) and a current state (i.e., an operation of the UE (e.g., a driving mode, a meeting mode, a movie watching mode, a call mode, a sleep mode and the like)) of the user.

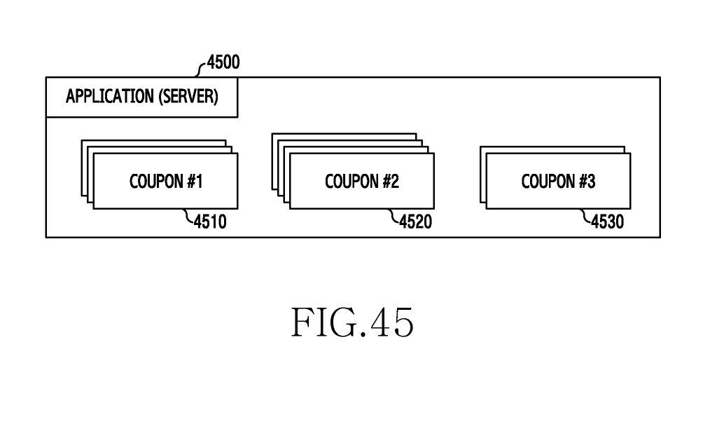

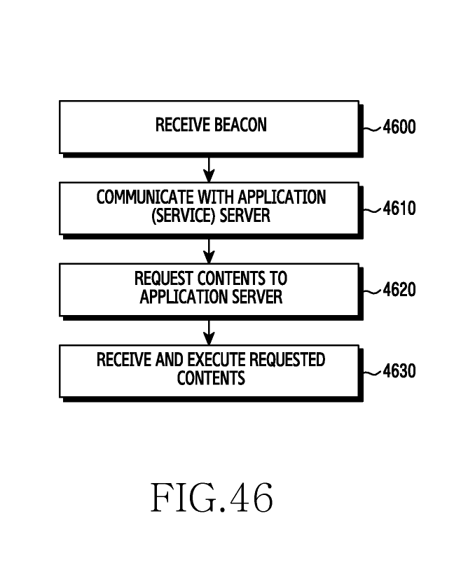

FIG. 45 is a diagram illustrating a configuration of an application having a plurality of pieces of content included in a server, according to an embodiment of the present disclosure. FIG. 46 is a flowchart illustrating a procedure for providing content based on a capability of a user and a UE state, according to an embodiment of the present disclosure. Referring to FIGS. 45 and 46, the application 4500 including the plurality of pieces of content (e.g., coupons #1 4510, coupons #2 4520, coupons #3 4530) may not be stored in the UE and may be stored in the server (e.g., an application (i.e., service) server).

In this case, in step 4600, the UE receives a beacon. According to an embodiment, the UE may obtain the beacon signal (e.g., an ibeacon and the like) through a communication interface.

In step 4610, the UE communicates with the application (i.e., service) server according to the received beacon. According to an embodiment, the UE may communicate with an application server related to a service corresponding to the beacon signal.

In step 4620, the UE requests content related to a corresponding service to the application server. According to an embodiment, the UE may transmit a transmission request message of the content related to the corresponding service to the application server. The UE may request proper content (e.g., a coupon) to the application server according to a capability (e.g., a used language, a disability or ability, an age and the like) and a current state (i.e., an operation mode (e.g., a meeting mode, a driving mode, a movement mode and the like) of the UE) of the user. For example, the UE may transmit a request message to the application server. A content type selected according to the capability and the current state of the user among the content identifier received through the beacon and the content type list received through the beacon may be included in the request message (e.g., a message, a packet and the like) transmitted to the application server. Thus, in step 4630, the UE receives corresponding content from the server to execute the corresponding content.

According to an embodiment, a process similar to the above-described process may also be performed in a ProSe. For example, an announce UE, which announces a ProSe application code, and a monitor UE, which monitors the ProSe application code, may transfer a discovery request to a ProSe function, and may receive the ProSe application code or a discovery filter in response to the discovery. The discovery request transferred from the announce UE to the ProSe function may further include information such as a content identifier and a content type list.

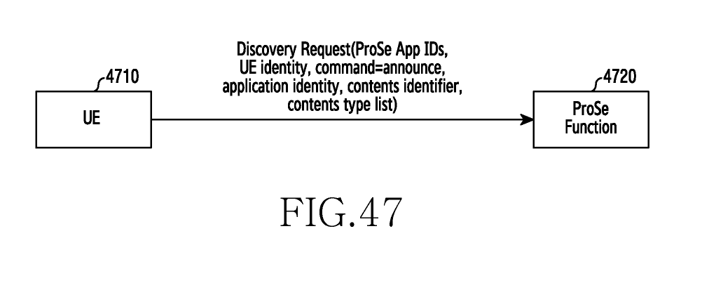

FIG. 47 is a diagram illustrating a procedure for transmitting a discovery request from a UE to a ProSe function, according to an embodiment of the present disclosure. As shown in FIG. 47, the ProSe function 4710 receives the discovery request from the UE 4710, and transfers a proper ProSe application code to an announce UE 4710 in response to the discovery. The ProSe function 4720 or a server connected to the ProSe function 4720 may have application related information (e.g., contents identifier, contents type list format and the like).

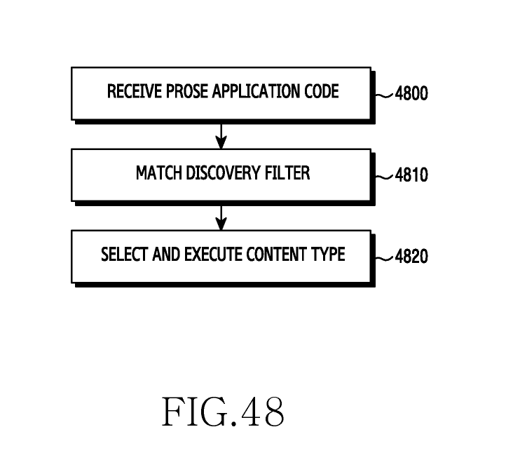

FIG. 48 is a flowchart illustrating a procedure for executing content by receiving a ProSe application code by a UE, according to an embodiment of the present disclosure. Referring to FIG. 48, in step 4800, the UE (e.g., a monitor UE) receives the ProSe application code. According to an embodiment, the monitor UE receives the ProSe application code through a communication interface.

In step 4810, the monitor UE performs a matching on the received ProSe application code through a discovery filter. For example, when the matching is performed but a ProSe application identifier cannot be identified, the monitor UE may further identify the ProSe application identifier through a match report process.

According to an embodiment, the monitor UE may identify the content identifier and the content type list through the match report process. For example, when the above-described information (e.g., the contents identifier, the contents type list and the like) are stored in the UE, an additional match report process may be omitted later.

In step 4820, the monitor UE selects and executes the content type. The monitor UE may select and execute a proper content type according to a capability (e.g., a used language, a disability or ability, an age and the like) and a current state (i.e., an operation mode (e.g., a meeting mode, a driving mode, a movement mode and the like) of the UE) of the user.

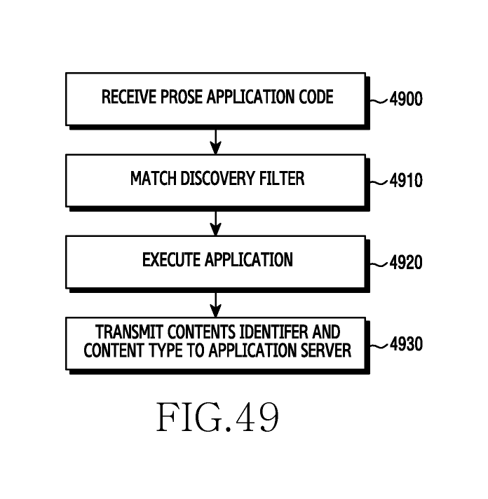

FIG. 49 is a flowchart illustrating a procedure for transmitting a content identifier and a content type from a UE to an application server by receiving a ProSe application code, according to an embodiment of the present disclosure. Referring to FIG. 49, in step 4900, the UE (e.g., a monitor UE) receives a ProSe application code. In step 4910, the UE matches the ProSe application code through a discovery filter. When the matching is performed but a ProSe application identifier cannot be identified, the monitor UE may further identify the ProSe application identifier through a match report process. The monitor UE may identify the content identifier and the content type list through the match report process. For example, when the above-described information is stored in the UE, an additional match report process may be omitted later.

In step 4920, the monitor UE executes a corresponding application. According to an embodiment, when content is not in the UE, the UE may request corresponding content from an application server.

In step 4930, the monitor UE transmits the content identifier and the content type to the application server. According to an embodiment, the monitor UE may transmit the content identifier and the selected content type according to a capability (e.g., a used language, a disability or ability, an age and the like) and a current state (i.e., an operation mode (e.g., a meeting mode, a driving mode, a movement mode, and the like) of the UE) of the user.

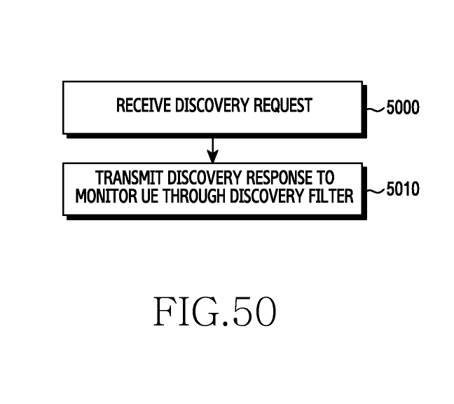

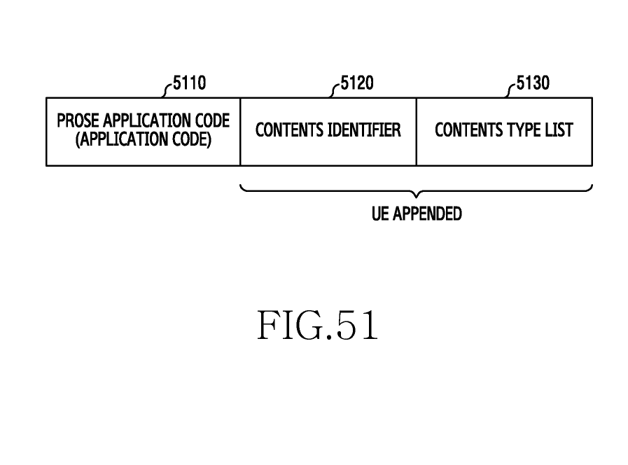

FIG. 50 is a flowchart illustrating a procedure for transmitting a discovery filter as a discovery response from a ProSe function to a monitor UE because the ProSe function receives a discovery request, according to an embodiment of the present disclosure. A procedure in which the monitor UE transmits the discovery request to the ProSe function and receives the discovery filter as the discovery response. FIG. 51 is a diagram illustrating a configuration of an application (i.e., a service), according to an embodiment of the present disclosure.

Referring to FIG. 50, in step 5000, the ProSe function receives the discovery request, and in step S010, the ProSe function transfers the discovery response to the monitor UE through a proper discovery filter.

According to an embodiment, only some of a content identifier and a content type may be transmitted in the discovery request process. For example, information corresponding to English may be transferred as a selected contents type to utilize the information corresponding to English as a purpose of filtering in a filtering process. For example, information corresponding to a TTS function may be transferred as the selected content type to utilize the information corresponding to the TTS function as a purpose of executing only contents related to the TTS function in the filtering process.

According to an embodiment, an announce UE may not transmit the above-described content identifier and content type list to the ProSe function. As shown in FIG. 51, the announce UE may autonomously attach the content identifier 5120 and the content type list 5130 in the transferred ProSe application code 5110 as a response by utilizing the existing discovery request. In this case, a process of identifying the content and the content type may be performed in an application layer.

According to an embodiment, identification information of a user may not be transferred in a communication process with an application server. Communication for transmitting or receiving content may be performed in an anonymous state. When content suitable for the UE are not included in the received content type list 5130, the UE may filter it out. Alternatively, an additional function may be performed in a method suitable for a user to provide the additional function to the user.

For example, when only a Japanese coupon is provided to a user who cannot read Japanese, Japanese may be translated into a language that can be read by the user. In a case of an image coupon, an Optical Character Reader (OCR) function may be additionally performed for translation.

For example, when a coupon is provided to a user having a visual impairment, a UE having a TTS function may provide information of the coupon by utilizing the TTS function. In a case of the image coupon, the OCR function may be additionally performed for the TTS function.

For example, when a coupon is provided to a user having a visual impairment, a UE having a pin screen function (i.e., a function of displaying a braille on a screen) may provide the coupon to the user by utilizing the pin screen. In a case of an image coupon, the OCR function may be additionally performed for the pin screen (i.e., the braille on the screen) function.

After a proper coupon is provided to the user through the above-described process, in order to substantially use the coupon, the UE executing the coupon may be transferred to a counterpart (e.g., a store clerk) in front of a POS. The UE recognizes this, and thus, the UE may enable the counterpart (e.g., store clerk) to select the proper coupon.

For example, a Japanese version of a corresponding coupon may be displayed as soon as a UE is transferred to a clerk, by recognizing a gesture of providing the UE to the clerk of a Japanese store in Japan.

As another example, a Japanese version of a corresponding coupon may be displayed as soon as a UE is transferred to a clerk of a Japanese store, by utilizing a received signal strength and a received signal to noise ratio.

In another example, a Japanese version of a corresponding coupon may be displayed as soon as a UE is transferred to a clerk of a Japanese store through other devices (e.g., a camera of a head mounted device and the like) connected to the UE.

According to an embodiment, a capability of the user may include at least one of setting information (e.g., language or user configuration information) of the UE, a cloud of a user address, various pieces of content information (e.g., document, music, video files) stored in a different device frequently used by the user, various pieces of address information, and language information of a webpage accessed by the user. The UE may obtain the language information of the user using at least one of the above-described pieces of the information. The UE may also determine whether the user is disabled, an age, and the like, by using the setting information, the address information of the user, and the like.

According to an embodiment, the UE may determine status information of the UE by utilizing schedule application information of the UE, information on various sensors and the like.

According to various embodiments, the UE may provide a method of transferring information on only an affiliated store to a surrounding UE.

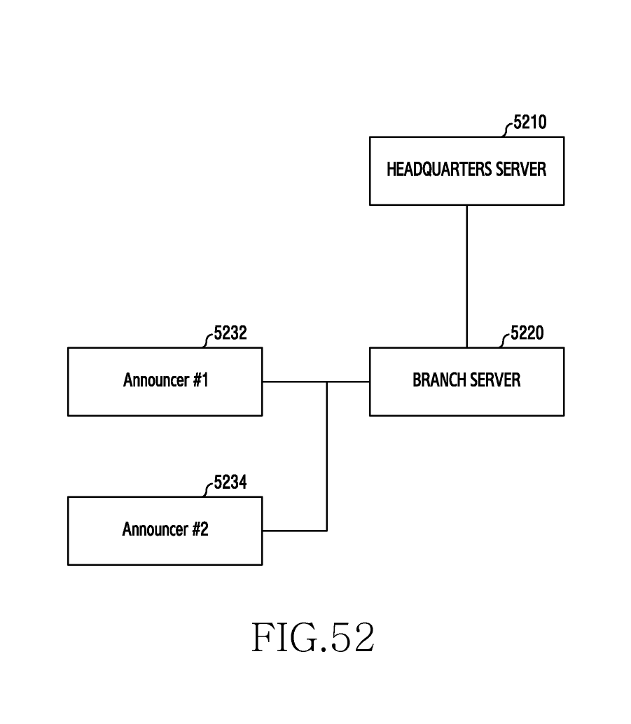

FIG. 52 is a diagram illustrating a network environment among a headquarters server, a branch (e.g., an affiliated store) server, and an announcer, according to an embodiment of the present disclosure. For example, the headquarters server 5210 may be a server of a specific brand headquarters, and the branch server 5220 may be a server of an affiliated store of the specific brand. The announcer (e.g., an announcer #1 5232, an announcer #2 5234, and the like) may be announcers installed in the affiliated store of the specific brand.

According to an embodiment, a plurality of announcers may perform wired or wireless communication with the branch server 5220. The branch server 5220 may communicate with the headquarters server 5210.

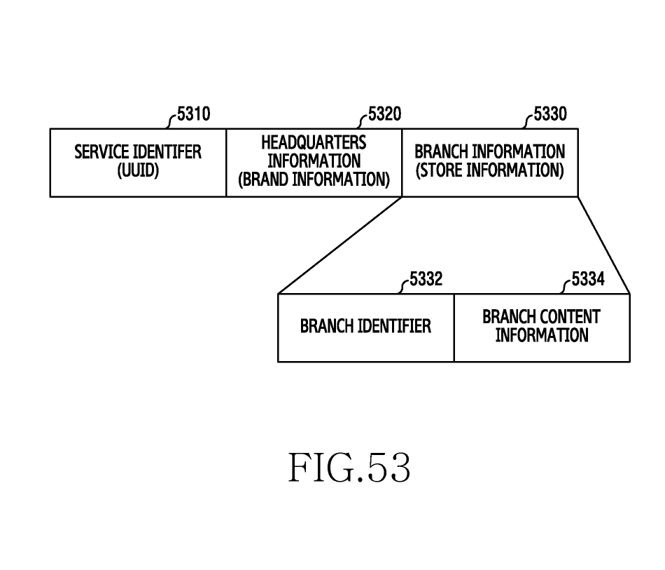

FIG. 53 is a diagram illustrating a configuration of an announcement, according to an embodiment of the present disclosure. According to an embodiment, in a case of an ibeacon, the announcement may have a configuration as shown in FIG. 53. The announcement includes a service identifier 5310, headquarters information 5320, and branch information 5330. For example, the headquarters information 5320 may include information capable of receiving contents (e.g., a headquarters coupon, headquarters information and the like), which may be provided from headquarters. Corresponding content (e.g., the headquarters coupon, the headquarters information and the like) may be provided from the headquarters server.

For example, the branch information 5310 may include a branch identifier 5332 (or store identifier) specifying a branch and branch content information 5334 (e.g., a branch coupon, branch information and the like), which may be provided from the branch. For example, corresponding content (e.g., the branch coupon, the branch information, and the like) may be provided from the branch server.

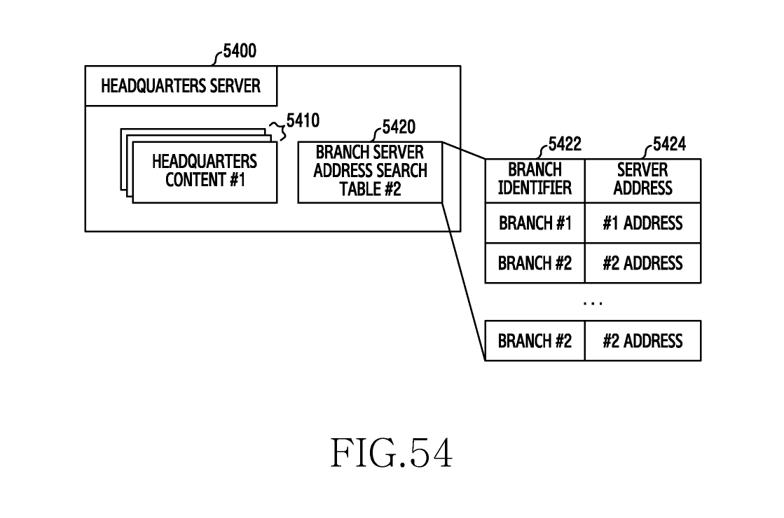

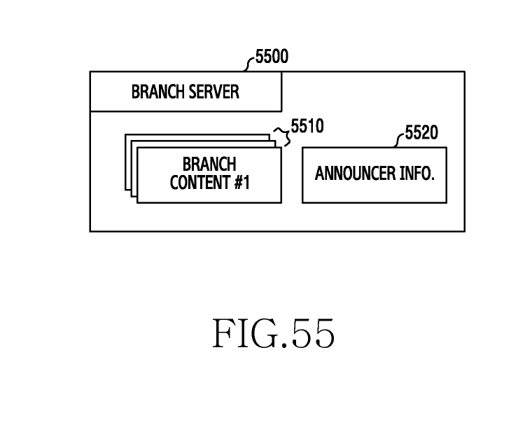

FIG. 54 is a diagram illustrating a configuration of a database included in a headquarters server, according to an embodiment of the present disclosure. FIG. 55 is a diagram illustrating a configuration of a database included in a branch server, according to an embodiment of the present disclosure.

Referring to FIG. 54, the database in the headquarters server 5400 may include headquarters related content 5410 (e.g., a coupon, an advertisement, a location, and the like)). Index information for the headquarters related content 5410 may be included in headquarters content information.

According to an embodiment, headquarters information field information may be transferred to the branch server. For example, the headquarters server 5400 may have a branch server address search table 5420. For example, the branch server address search table 5420 may include a branch identifier field 5422 and a list of a branch address field 5424 of a corresponding branch.

Referring to FIG. 55, the branch server may include branch content (e.g., a coupon, an advertisement, a shop map and the like). Here, index information for branch related content may be included in branch content information.

According to an embodiment, the branch server 5500 may receive content 5510 included in the headquarters information from the headquarters server. The branch server 5500 may know the branch identifier in advance, or when the branch server 5500 does not know the branch identifier, the branch identifier may be transferred from the headquarters server to the branch server 5500. The branch server 5500 may collect these pieces of information to complete an announcement, and may distribute the announcement to announcers of a corresponding branch. Here, the branch server 5500 may have announcer related information 5520 (e.g., an announcer identifier (e.g., a mac address)) of the branch. The announcers of the branch may be installed in several places in the branch.

According to an embodiment, when the branch server 5500 has the announcer identifier, the branch server 5500 may provide a location service in the branch by utilizing the announcer identifier. For example, the UE may display today's coffee information in front of a door of a specific shop, may display cookie information, which is good for eating together in front of a Point Of Sale (POS) device, and may display tumbler information at a table. In addition, an application may perform a different operation according to a sequence of an announcer received in a predetermined period.

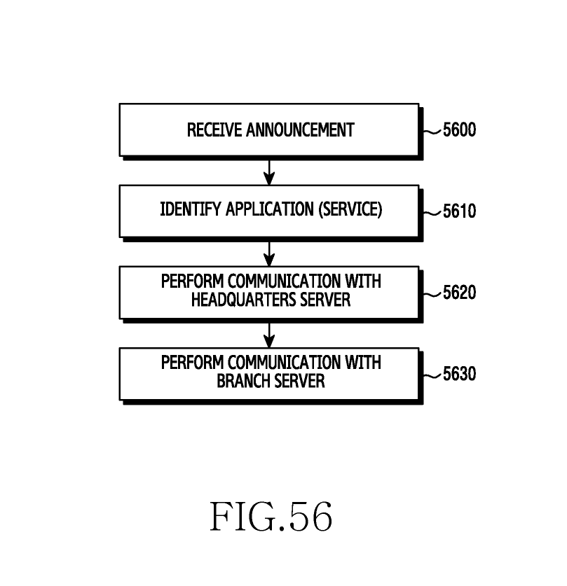

FIG. 56 is a flowchart illustrating a procedure for performing communication between a UE and a branch server, according to an embodiment of the present disclosure. Referring to FIG. 56, in step 5600, the UE receives and decode an announcement.

In step 5610, the UE identifies (or checks) an application (i.e., service) through a service identifier (i.e., UUID).

In step 5620, the UE starts communication with a headquarters server by utilizing information of the identified application (i.e., service). For example, an application installed in the UE may include an address capable of accessing the application.

According to an embodiment, the UE may transmit headquarters information and a branch identifier included in the announcement to the headquarters server in a process of communicating with the headquarters server. The headquarters server may transfer headquarters contents corresponding to the headquarters information to the UE in response to the transmission. For example, the headquarters server may transfer a branch server address in response to the branch identifier to the UE by utilizing a branch server address search table.

In step 5630, the UE performs communication with the branch server by utilizing a corresponding address. According to an embodiment, the UE may transmit the branch information in the announcement to the branch server. The branch server may transmit branch contents corresponding to the branch information to the UE in response to this. For example, an announcer identifier also may be additionally transmitted in a process of communicating with the branch server. The branch server receiving the announcer identifier may provide branch contents related to a location where a corresponding announcer is installed to the UE.

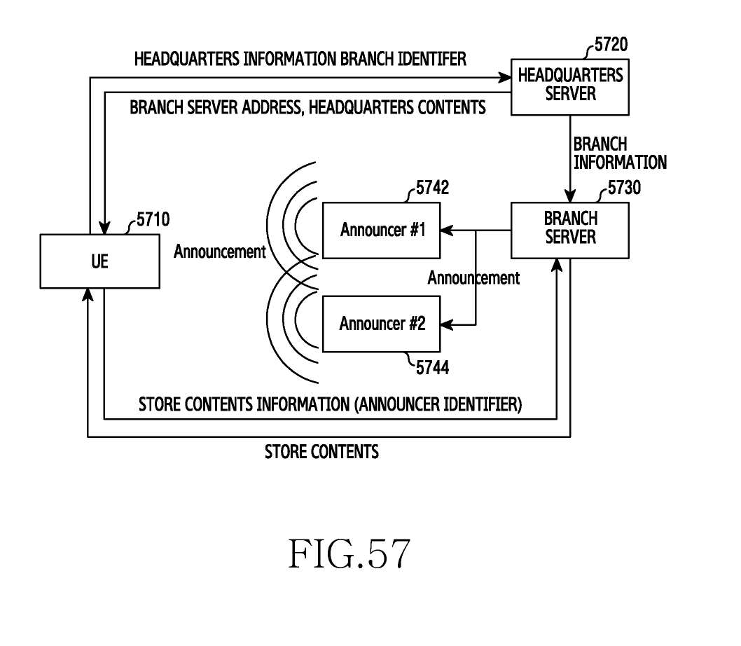

FIG. 57 is a diagram illustrating a network environment among a headquarters server, a branch server, a UE, and an announcer, according to an embodiment of the present disclosure.

Referring to FIG. 57, the headquarters server 5720 receives a headquarters information branch identifier from the UE 5710. The headquarters server 5720 provides branch information to a corresponding branch server 5730 according to the headquarters information branch identifier. The branch server 5730 provides an announcement to corresponding announcer #1 5742 and announcer #2 5744.

According to an embodiment, the branch server 5730 stores content information (e.g., an announcer identifier) through the UE 5710, and the UE 5710 stores corresponding content through the branch server 5730.

According to an embodiment, the branch server may receive specific information from the headquarters server in a communication process with the headquarters server. For example, the branch server may receive a key value necessary in a communication process between the branch server and the headquarters server from the headquarters server.

A method for operating an electronic device according to various embodiments of the present disclosure may comprise receiving a wireless signal, determining whether a service corresponding to the wireless signal is activated or deactivated, and outputting content related to the service based on whether the service is activated or deactivated.

According to various embodiments, determining whether the service is activated or deactivated is based on at least one of an identifier, a search filter, a server address of the service corresponding to the wireless signal.

According to various embodiments, the outputting content related to the service may comprise outputting the content related to the service based on at least one of a capability of a user of the electronic device, information on whether the electronic device is moved or fixed, information on a mobility of the electronic device, and an operation mode of the electronic device.

According to various embodiments, the capability of the user of the electronic device may include at least one of a language configured in the electronic device, a disability of the user, an ability of the user, and an age of the user.

According to various embodiments, the operation mode of the electronic device may include at least one of a driving mode, a meeting mode, a movie watching mode, a call mode, and a sleep mode configured in the electronic device.

According to various embodiments, extracting the content related to the service from the received wireless signal may further be included, before outputting the content related to the service, when the service is activated.

According to various embodiments, outputting the content related to the service comprise obtaining the content related to the service from a server, when the service is activated, and outputting the content related to the service.

According to various embodiments, outputting the content related to the service comprise generating at least one of a vibration, a sound, and a screen turning on corresponding to activation of the service, when the service is activated.

According to various embodiments, outputting the content related to the service comprise outputting information for determining whether the service is activated, when the service is not activated.

According to various embodiments, transmitting the content to at least one external electronic device, when a sharing event for the content related to the service is generated may further be included.

The term “module”, as used herein, refers to a unit including one of hardware, software, and firmware, or a combination of two or more of them, for example. For example, the term “module” may be used interchangeably with terms like “unit”, “logic”, “logical block”, “component”, or “circuit”. A module may be a minimum unit of an integrally configured part or a part of it. A module may be a minimum unit that performs one or more functions or a part of it. A module may be implemented mechanically or electronically. For example, a module may include at least one of an Application Specific Integrated Circuit (ASIC) chip, Field Programmable Gate Arrays (FPGAs), and a programmable logic device that performs any operation that is already well known or will be developed in the future.

At least part of the apparatus (for example, modules or functions) or method (for example, operations), according to various embodiments, may be implemented by using instructions stored in a computer-readable storage media in the form of a programming module. When the instructions are executed by one or more processors (for example, the processor 120), the one or more processors may perform a function corresponding to the instructions. The computer-readable storage media may be the memory 130, for example.

Examples of the computer-readable recording medium include hard disks, floppy disks, magnetic media (for example, magnetic tapes), optical media (for example, Compact Disc Read Only Memories (CD-ROMs), Digital Versatile Disc (DVDs), magneto-optical media (for example, floptical disks)), and hardware devices (for example, Read Only Memories (ROMs), Random Access Memories (RAMs) and flash memories). Examples of the program commands include machine language codes created by a compiler, and high-level language codes that can be executed by a computer by using an interpreter. The above-described hardware devices may be configured to operate as one or more software modules for performing operations of various embodiment of the present disclosure, and vice versa.

A module or programming module, according to various embodiments, may include one or more of the above-described elements, may omit some elements, or may further include additional elements. The operations performed by the module, the programming module, or the other elements, according to various embodiments, may be performed serially, in parallel, repeatedly, or heuristically. In addition, some operation may be performed in different order or may be omitted, and additional other operations may be added.

According to various embodiments, a computer-readable recording medium storing instructions may be a computer-readable recording medium in which a program for executing operations is recorded. The operation may include receiving a wireless signal, identifying an activation or deactivation of a service corresponding to the received wireless signal, and outputting contents related to the service based on the activation or deactivation of the service.

According to various embodiments, an electronic device may selectively receive service related contents in consideration of a capability of a user or a state of the user.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An electronic device comprising:
a communication interface;
an output device; and
a processor configured to receive a wireless signal through the communication interface, determine whether a service corresponding to the wireless signal is activated or deactivated, and output content related to the service through the output device based on whether the service is activated or deactivated.

2. The electronic device of claim 1, wherein the processor is further configured to determine whether the service is activated or deactivated based on at least one of an identifier, a search filter, a server address of the service corresponding to the wireless signal.

3. The electronic device of claim 1, wherein the processor is further configured to output the content related to the service based on at least one of a capability of a user of the electronic device, information on whether the electronic device is moved or fixed, information on a mobility of the electronic device, and an operation mode of the electronic device.

4. The electronic device of claim 3, wherein the capability of the user of the electronic device includes at least one of a language configured in the electronic device, a disability of the user, an ability of the user, and an age of the user.

5. The electronic device of claim 3, wherein the operation mode of the electronic device includes at least one of a driving mode, a meeting mode, a movie watching mode, a call mode, and a sleep mode configured in the electronic device.

6. The electronic device of claim 1, wherein, when it is determined that the service is activated, the processor is further configured to extract the content related to the service from the wireless signal.

7. The electronic device of claim 1, wherein, when it is determined that the service is activated, the processor is further configured to obtain the content related to the service from a server.

8. The electronic device of claim 1, wherein, when it is determined that the service is activated, the processor is further configured to control the output device such that the output device generates at least one of a vibration, a sound, and a screen turning on corresponding to the activation of the service.

9. The electronic device of claim 1, wherein, when the service it is determined that the service is deactivated, the processor is further configured to control the output device such that the output device outputs information for determining whether the service is activated.

10. The electronic device of claim 1, wherein, when a sharing event for the content related to the service output through the output device is generated, the processor is further configured to control the communication interface such that the communication interface transmits the content to at least one external electronic device.

11. A method for operating an electronic device, the method comprising:
receiving a wireless signal;
determining whether a service corresponding to the wireless signal is activated or deactivated; and
outputting content related to the service based on whether the service is activated or deactivated.

12. The method of claim 11, wherein determining whether the service is activated or deactivated is based on at least one of an identifier, a search filter, a server address of a service included in the wireless signal corresponding to the wireless signal.

13. The method of claim 11, wherein outputting content related to the service comprises outputting the content related to the service based on at least one of a capability of a user of the electronic device, information on whether the electronic device is moved or fixed, information on a mobility of the electronic device, and an operation mode of the electronic device.

14. The method of claim 13, wherein the capability of the user of the electronic device includes at least one of a language configured in the electronic device, a disability of the user, an ability of the user, and an age of the user.

15. The method of claim 13, wherein the operation mode of the electronic device includes at least one of a driving mode, a meeting mode, a movie watching mode, a call mode, and a sleep mode configured in the electronic device.

16. The method of claim 11, further comprising:
extracting the content related to the service from the received wireless signal, before the outputting the content related to the service, when the service is activated.

17. The method of claim 11, wherein outputting the content related to the service comprises:
obtaining the content related to the service from a server, when the service is activated; and
outputting the content related to the service.

18. The method of claim 11, wherein outputting the content related to the service comprises generating at least one of a vibration, a sound, and a screen turning on corresponding to activation of the service, when the service is activated.

19. The method of claim 11, wherein outputting the content related to the service comprises outputting information for determining whether the service is activated, when the service is not activated.

20. The method of claim 11, further comprising:
transmitting the content to at least one external electronic device, when a sharing event for the content related to the service is generated.
